(19) United States
(12) Patent Application Publication
(10) Pub. No.: US 2023/0252299 A1
(43) Pub. Date: Aug. 10, 2023

(54) DETECTING AND MITIGATING FAULT IN SPARSITY COMPUTATION IN DEEP NEURAL NETWORK

(71) Applicants: Shamik Kundu, Dallas, TX (US); Arnab Raha, San Jose, CA (US); Deepak Abraham Mathaikutty, Chandler, AZ (US)

(72) Inventors: Shamik Kundu, Dallas, TX (US); Arnab Raha, San Jose, CA (US); Deepak Abraham Mathaikutty, Chandler, AZ (US)

(21) Appl. No.: 18/304,713

(22) Filed: Apr. 21, 2023

(51) Int. Cl. G06N 3/08

(52) U.S. Cl. CPC G06N 3/08

(57) ABSTRACT

Computations in processing elements (PEs) for executing a deep neural network (DNN) may be accelerated based on sparsity. A compressed activation operand and a compressed weight operand may be stored. The compressed activation operand includes one or more nonzero activations in an activation operand. The compressed weight operand includes one or more nonzero weights in a weight operand. A sparsity module associated with the PE may generate a bitmap based on an activation sparsity vector of the activation operand and a weight sparsity vector of the weight operand. The sparsity module identifies a nonzero activation (or a nonzero weight) from the compressed activation operand (or the compressed weight operand) based on the bitmap. The sparsity module may detect a fault in identifying the nonzero activation or the nonzero weight based on the number of one or more nonzero elements in the bitmap. The sparsity module may further mitigate the fault.

### TECHNICAL FIELD

This disclosure relates generally to neural networks, and more specifically, detecting and mitigating faults in sparsity computations in deep neural networks (DNNs).

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as a large amount of data to read and write. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figure (FIG. 1 illustrates an example DNN, in accordance with various embodiments.

FIG. 2 illustrates an example convolution, in accordance with various embodiments.

FIG. 3 is a block diagram of a DNN accelerator, in accordance with various embodiments.

FIG. 4 is a block diagram of a compute block, in accordance with various embodiments.

FIG. 5 illustrates a processing element (PE) array, in accordance with various embodiments.

FIG. 6 is a block diagram of a PE, in accordance with various embodiments.

FIG. 7 illustrates sparsity acceleration in an MAC operation by a PE, in accordance with various embodiments.

FIG. 8 illustrates a sparsity computation for identifying a pair of nonzero valued activation and nonzero valued weight, in accordance with various embodiments.

FIG. 9 illustrates detection of faults in sparsity computation, in accordance with various embodiments.

FIG. 10 illustrates mitigation of a computational error in sparsity computation, in accordance with various embodiments.

FIG. 11 is a flowchart showing a method of detecting faults in sparsity computations, in accordance with various embodiments.

FIG. 12 is a block diagram of an example computing device, in accordance with various embodiments.

### DETAILED DESCRIPTION

Overview

The last decade has witnessed a rapid rise in AI (artificial intelligence) based data processing, particularly based on DNNs. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

A DNN layer may include one or more deep learning operations, such as convolution, pooling, elementwise operation, linear operation, nonlinear operation, and so on. A deep learning operation in a DNN may be performed on one or more internal parameters of the DNNs (e.g., weights), which are determined during the training phase, and one or more activations. An activation may be a data point (also referred to as “data elements” or “elements”). Activations or weights of a DNN layer may be elements of a tensor of the DNN layer. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (also referred to as “input feature map (IFM)”) including one or more input activations (also referred to as “input elements”) and a weight tensor including one or more weights. A weight is an element in the weight tensor. A weight tensor of a convolution may be a kernel, a filter, or a group of filters. The combination of the input activation(s) and weight(s) may be referred to as input data of the DNN layer. The output data of the DNN layer may be an output tensor (also referred to as “output feature map (OFM)”) that includes one or more output activations (also referred to as “output elements”).

An accelerator for DNN (“DNN accelerator”) may include one or more large arrays of PEs which operate concurrently in executing the layers in a DNN. The PEs may perform deep learning operations. For instance, for a convolution, the PEs can perform MAC operations on activation and weights. Input tensors or weight tensors can include zero valued elements that do not impact the output of the dot product. DNN accelerators can exploit the sparsity in such input tensors or weigh tensors to accelerate deep learning operations in DNNs, which can lead to higher speedup or throughput as well as less energy consumption. For instance, a DNN accelerator may include a sparsity acceleration unit that can be used to skip the processing of the zero valued activations or zero valued weights by the PEs.

However, such sparsity-based DNN accelerators are susceptible to circuit-level hardware faults, such as hardware faults caused by aging, temperature, process variations, soft errors, and so on. The hardware faults can lead to errors in the outputs of the DNNs run by the DNN accelerators. Hardware faults in DNN accelerators may be transient faults or permanent faults. Transient faults can be induced by impingement of high-energy particles and cause temporary errors in the datapath. Permanent faults can escape the manufacturing screening process and manifest themselves as latent defects due to structural deformities, such as overlapping vias and partial shorts and opens, etc. Transformation to hard defects during in-field operation and transistor aging can accelerate the degradation of such latent defects and hasten the manifestation of permanent faults. Circuit-level hardware faults not only can introduce graceless misclassification, but also can result in control failure in sparsity acceleration logic of DNN accelerators. Even though a sparsity acceleration unit may constitute a relatively small fraction of the overall area and power overhead of the DNN accelerator, it can be critical to detect and mitigate faults in the sparsity acceleration unit as such faults can have disruptive impact on the overall inference accuracy of DNNs. The impact caused by faults in the sparsity acceleration unit can sometimes be higher than impact caused by faults in the PEs.

Software-based fault addressing schemes have been proposed. However, such techniques cannot alleviate characteristic fault manifestation in hardware accelerators. Also, even though the impact of memory faults in DNN accelerators has been addressed, the impact of datapath faults has been ignored. May currently available techniques for addressing faults in DNN accelerators also suffer from the disadvantage of adding substantial area and power overhead. These techniques are not applicable to resource constrained DNN accelerators, such as DNN accelerators operating at the edge. Therefore, improved techniques for addressing faults in DNN accelerators are needed.

Embodiments of the present disclosure may improve on at least some of the challenges and issues described above by dynamically detecting and mitigating faults in sparsity computations in DNNs. An DNN accelerator in the present disclosure can accelerate deep learning operations in DNN layers by storing and processing compressed input data. The compressed input data of a DNN layer includes data that would influence the output of the DNN layer and excludes data that does not influence the output of the DNN layer. Taking a convolutional layer for example, the compressed input data for an MAC operation in the convolution may include a compressed activation operand and a compressed weight operand. The MAC operation has an activation operand including a sequence of activations and a weight operand including a sequence of weights. The MAC operation includes a sequence of multiplications, each of which is on an activation-weight pair. The position of the activation in the activation operand may match the position of the weight in the weight operand. The products from the sequence of multiplications may be accumulated to generate a single data point. zero valued activations or zero valued weight would not contribute to the result of the accumulation as the product of the activation or weight with any number would be zero. The compressed activation operand includes one or more nonzero valued activations in the activation operand for the MAC operation. The compressed weight operand includes one or more nonzero valued weights in the weight operand for the MAC operation. The compressed input data does not include zero valued data points. Accordingly, the position of an activation (or weight) in the compressed activation operand (or compressed weight operand) can be different from the position of the activation (or weight) in the activation operand (or weight operand).

In various embodiments of the present disclosure, the DNN accelerator includes a sparsity module that can facilitate the acceleration of deep learning operation by determining positions of activations in compressed activation operands and positions of weights in compressed weight operand through sparsity computations. The sparsity module may perform a sequence of sparsity computation rounds for an MAC operation. Each round may be for identifying an activation-weight pair. The sparsity module can also detect and mitigate faults in its sparsity computations to avoid the negative impact of the faults on the performance of the DNN accelerator or accuracy of the DNN.

In an example, the sparsity module may obtain an activation bitmap and a weight bitmap. The activation bitmap includes a sequence of bits indicating whether each of the activations in the activation operation is zero or nonzero. The weight bitmap includes a sequence of bits indicating whether each of the weights in the weight operation is zero or nonzero. In each round of sparsity computation, the sparsity module may generate an activation position bitmap and a weight position bitmap based on the activation bitmap and weight bitmap. The activation position bitmap indicates the position of the activation in the compressed activation operand. For instance, the number of ones in the activation position bitmap may be the position index of the activation in the compressed activation operand. Similarly, the weight position bitmap indicates the position of the weight in the compressed weight operand. The sparsity module may use the position index to read the activation and weight from one or more memories storing the compressed activation operand and compressed weight operand and provide the activation and weight to a PE for performing the MAC operation.

The sparsity module may detect computational errors (e.g., errors in the activation position bitmap or weight position bitmap) by comparing the number of ones in the activation position bitmap with the number of ones in the activation bitmap or comparing the number of ones in the weight position bitmap with the number of ones in the weight bitmap. After a computational error is detected, the sparsity module may mitigate the computational error. The sparsity module may select different mitigation mechanisms based on the available or desirable amount of resources (e.g., power, area, time, etc.) for mitigating the computational error. For example, the sparsity module may determine whether a fault is permanent or transient. For a permanent fault, the sparsity module may deactivate fault detection and keep fault mitigation on till the end of the MAC operation, the end of the deep learning operation, or even the end of the DNN inference process. As another example, the sparsity module may use a redundancy mechanism, which can compute multiple activation position bitmaps or multiple weight position bitmaps for a single activation-weight pair, for applications where there is sufficient resources to facilitate the redundant sparsity computation. The sparsity module may alternatively use a non-redundancy mechanism to accommodate resource-limited applications. For instance, instead of computing redundant activation position bitmaps or multiple weight position bitmaps, the sparsity module may identify an activation or weight arranged immediately after the activation or weight identified in the previous round.

Additionally or alternatively, the sparsity module can detect one or more control failures in the sparsity computation round based on one or more intermediate bitmaps generated during the sparsity computation round. An example of the intermediate bitmaps is a control bitmap that is generated based on an initial control bitmap, which may be generated from the previous round of sparsity computation, and is used to generate a succeeding control bitmap, which can be used in the next round of sparsity computation. The control bitmap can therefore inherit computation information from the previous round or carry computation information to the next round. The sparsity module may determine whether there is a control failure based on the control bitmap in the current round and the control bitmap from the previous round. After a control failure is detected, the sparsity module can mitigate the control failure by replacing the control bitmap with a new control bitmap generated based on the control bitmap from the previous round. The current round can continue with the new control bitmap.

The present disclosure provides an in-field detection and dynamic mitigation framework that can address circuit-level faults in sparsity computations by DNN accelerators. Such a framework can reduce or even mitigate the influence of such faults on the accuracy of the DNNs or performance of the DNN accelerators without causing significant overhead. The framework can also provide flexibility for resource-limited applications, e.g., applications running on edge devices.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

Example DNN

FIG. 1 illustrates an example DNN 100, in accordance with various embodiments. For purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For the purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is rectified linear unit (ReLU). ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

Example Convolution

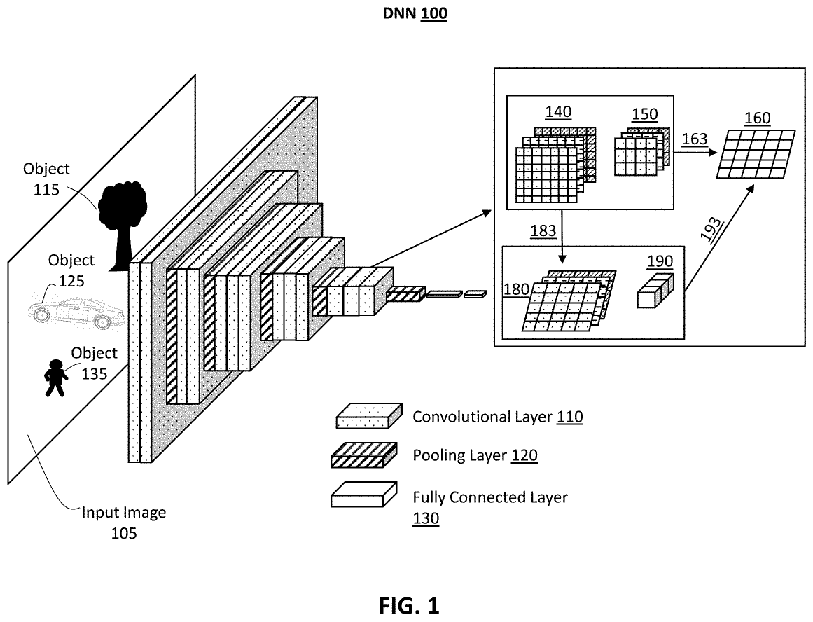

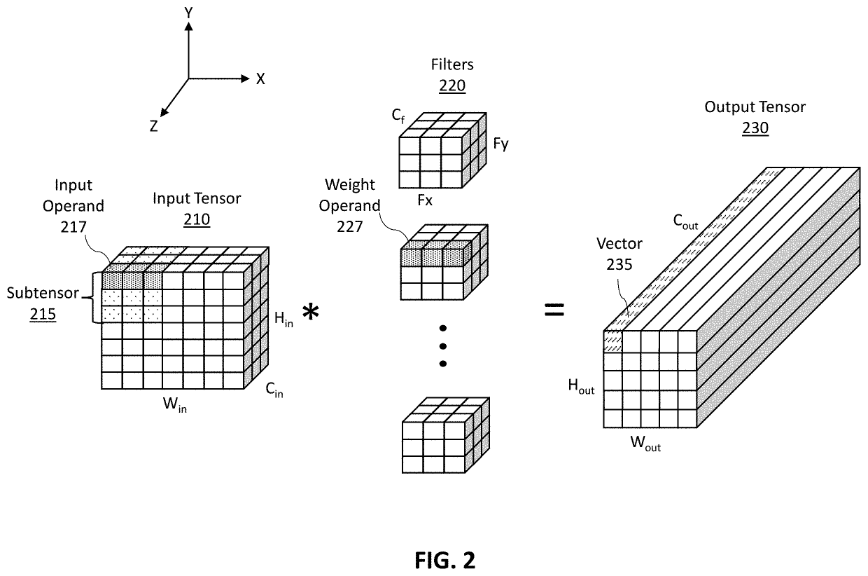

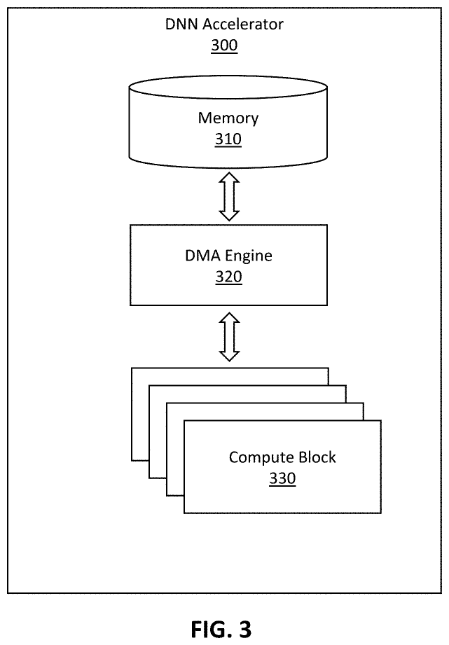

FIG. 2 illustrates an example convolution, in accordance with various embodiments. The convolution may be a convolution in a convolutional layer of a DNN, e.g., a convolutional layer 110 in FIG. 1. The convolutional layer may be a frontend layer. The convolution can be executed on an input tensor 210 and filters 220 (individually referred to as “filter 220”). A result of the convolution is an output tensor 230. In some embodiments, the convolution is performed by a DNN accelerator including one or more compute block. An example of the DNN accelerator may be the DNN accelerator 300 in FIG. 3. Examples of the compute blocks may be the compute blocks 325 in FIG. 3.

In the embodiments of FIG. 2, the input tensor 210 includes activations (also referred to as “input activations,” “elements,” or “input elements”) arranged in a 3D matrix. An activation in the input tensor 210 is a data point in the input tensor 210. The input tensor 210 has a spatial size Hᵢₙ×Wᵢₙ×Cᵢₙ, where Hᵢₙ is the height of the 3D matrix (i.e., the length along the Y axis, which indicates the number of activations in a column in the 2D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For purpose of simplicity and illustration, the input tensor 210 has a spatial size of 7×7×3, i.e., the input tensor 210 includes three input channels and each input channel has a 7×7 2D matrix. Each input element in the input tensor 210 may be represented by a (X, Y, Z) coordinate. In other embodiments, the height, width, or depth of the input tensor 210 may be different.

Each filter 220 includes weights arranged in a 3D matrix. The values of the weights may be determined through training the DNN. A filter 220 has a spatial size H_{f}×W_{f}×C_{f}, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and C_{f} is the depth of the filter (i.e., the length along the Z axis, which indicates the number of channels). In some embodiments, C_{f} equals Cᵢₙ. For purpose of simplicity and illustration, each filter 220 in FIG. 2 has a spatial size of 3×3×3, i.e., the filter 220 includes 3 convolutional kernels with a spatial size of 3×3. In other embodiments, the height, width, or depth of the filter 220 may be different. The spatial size of the convolutional kernels is smaller than the spatial size of the 2D matrix of each input channel in the input tensor 210.

An activation or weight may take one or more bytes in a memory. The number of bytes for an activation or weight may depend on the data format. For example, when the activation or weight has an integral format (e.g., INT8), the activation takes one byte. When the activation or weight has a floating-point format (e.g., FP16 or BF16), the activation or weight takes two bytes. Other data formats may be used for activations or weights.

In the convolution, each filter 220 slides across the input tensor 210 and generates a 2D matrix for an output channel in the output tensor 230. In the embodiments of FIG. 2, the 2D matrix has a spatial size of 5×5. The output tensor 230 includes activations (also referred to as “output activations,” “elements,” or “output element”) arranged in a 3D matrix. An activation in the output tensor 230 is a data point in the output tensor 230. The output tensor 230 has a spatial size Hₒᵤₜ×Wₒᵤₜ×Cₒᵤₜ, where Hₒᵤₜ is the height of the 3D matrix (i.e., the length along the Y axis, which indicates the number of output activations in a column in the 2D matrix of each output channel), Wₒᵤₜ is the width of the 3D matrix (i.e., the length along the X axis, which indicates the number of output activations in a row in the 2D matrix of each output channel), and Cₒᵤₜ is the depth of the 3D matrix (i.e., the length along the Z axis, which indicates the number of output channels). Cₒᵤₜ may equal the number of filters 220 in the convolution. Hₒᵤₜ and Wₒᵤₜ may depend on the heights and weights of the input tensor 210 and each filter 220.

As a part of the convolution, MAC operations can be performed on a 3×3×3 subtensor 215 (which is highlighted with dot patterns in FIG. 2) in the input tensor 210 and each filter 220. The result of the MAC operations on the subtensor 215 and one filter 220 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 215 and all the filters 220 are finished, a vector 235 is produced. The vector 235 is highlighted with slashes in FIG. 2. The vector 235 includes a sequence of output activations, which are arranged along the Z axis. The output activations in the vector 235 have the same (x, y) coordinate, but the output activations correspond to different output channels and have different Z coordinates. The dimension of the vector 235 along the Z axis may equal the total number of output channels in the output tensor 230.

After the vector 235 is produced, further MAC operations are performed to produce additional vectors till the output tensor 230 is produced. For instance, a filter 220 may move over the input tensor 210 along the X axis or the Y axis, and MAC operations can be performed on the filter 220 and another subtensor in the input tensor 210 (the subtensor has the same size as the filter 220). The amount of movement of a filter 220 over the input tensor 210 during different compute rounds of the convolution is referred to as the stride size of the convolution. The stride size may be 1 (i.e., the amount of movement of the filter 220 is one activation), 2 (i.e., the amount of movement of the filter 220 is two activations), and so on. The height and width of the output tensor 230 may be determined based on the stride size.

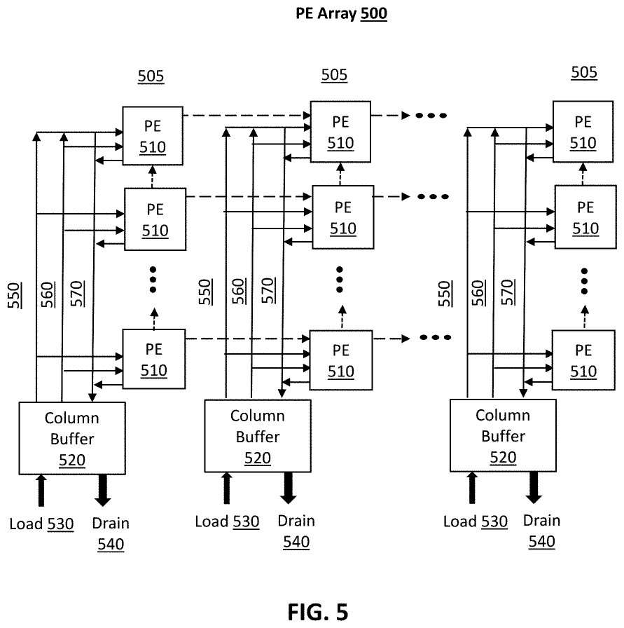

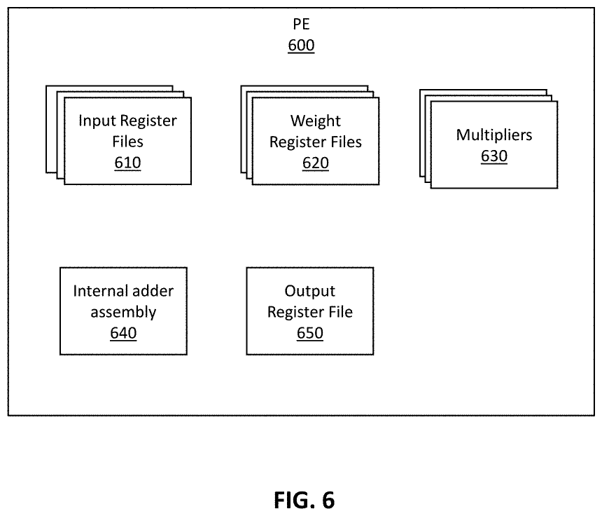

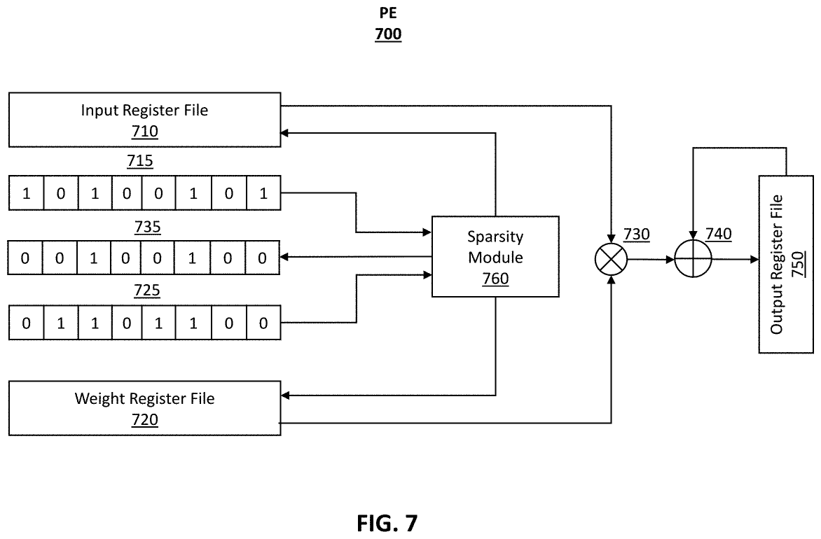

In some embodiments, the MAC operations on a 3×3×3 subtensor (e.g., the subtensor 215) and a filter 220 may be performed by a plurality of PEs, such as the PEs 510 in FIG. 5, the PE 600 in FIG. 6, or the PE 700 in FIG. 7. One or more MAC units may receive an activation operand (e.g., an activation operand 217 shown in FIG. 2) and a weight operand (e.g., the weight operand 227 shown in FIG. 2). The activation operand 217 includes a sequence of activations having the same (Y, Z) coordinate but different X coordinates. The weight operand 227 includes a sequence of weights having the same (Y, Z) coordinate but different X coordinates. The length of the activation operand 217 is the same as the length of the weight operand 227. Activations in the activation operand 217 and weights in the weight operand 227 may be sequentially fed into a PE. The PE may receive a pair of an activation and a weight at a time and multiple the activation and the weight. The position of the activation in the activation operand 217 may match the position of the weight in the weight operand 227.

Example DNN Accelerator

FIG. 3 is a block diagram of a DNN accelerator 300, in accordance with various embodiments. The DNN accelerator 300 can run DNNs, e.g., the DNN 100 in FIG. 1. The DNN accelerator 300 includes a memory 310, a DMA (direct memory access) engine 320, and compute blocks 330. In other embodiments, alternative configurations, different or additional components may be included in the DNN accelerator 300. For example, the DNN accelerator 300 may include more than one memory 310 or more than one DMA engine 320. As another example, the DNN accelerator 300 may include a single compute block 330. Further, functionality attributed to a component of the DNN accelerator 300 may be accomplished by a different component included in the DNN accelerator 300 or by a different system.

The memory 310 stores data to be used by the compute blocks 330 to perform deep learning operations in DNN models. Example deep learning operations include convolutions (also referred to as “convolutional operations”), pooling operations, elementwise operations, other types of deep learning operations, or some combination thereof. The memory 310 may be a main memory of the DNN accelerator 300. In some embodiments, the memory 310 includes one or more DRAMs (dynamic random-access memory). For instance, the memory 310 may store the input tensor, convolutional kernels, or output tensor of a convolution in a convolutional layer of a DNN, e.g., the convolutional layer 30. The output tensor can be transmitted from a local memory of a compute block 330 to the memory 310 through the DMA engine 320.

The DMA engine 320 facilitates data transfer between the memory 310 and local memories of the compute blocks 330. For example, the DMA engine 320 can read data from the memory 310 and write data into a local memory of a compute block 330. As another example, the DMA engine 320 can read data from a local memory of a compute block 330 and write data into the memory 310. The DMA engine 320 provides a DMA feature that allows the compute block 330 to initiate data transfer between the memory 310 and the local memories of the compute blocks 330 and to perform other operations while the data transfer is in being conducted. In some embodiments, the DMA engine 320 may read tensors from the memory 310, modify the tensors in a way that is optimized for the compute block 330 before it writes the tensors into the local memories of the compute blocks 330.

The compute blocks 330 perform computation for deep learning operations. A compute block 330 may run the operations in a DNN layer, or a portion of the operations in the DNN layer. A compute block 330 may perform convolutions, such as standard convolution (e.g., the standard convolution 163 in FIG. 1), depthwise convolution (e.g., the depthwise convolution 183 in FIG. 1), pointwise convolution (e.g., the pointwise convolution 193 in FIG. 1), and so on. In some embodiments, the compute block 330 receive an input tensor and one or more convolutional kernels and performs a convolution with the input tensor and convolutional kernels. The result of the convolution may be an output tensor, which can be further computed, e.g., by the compute block 330 or another compute block. In some embodiments, the operations of the DNN layers may be run by multiple compute blocks 330 in parallel. For instance, multiple compute blocks 330 may each perform a portion of a workload for a convolution. Data may be shared between the compute blocks 330.

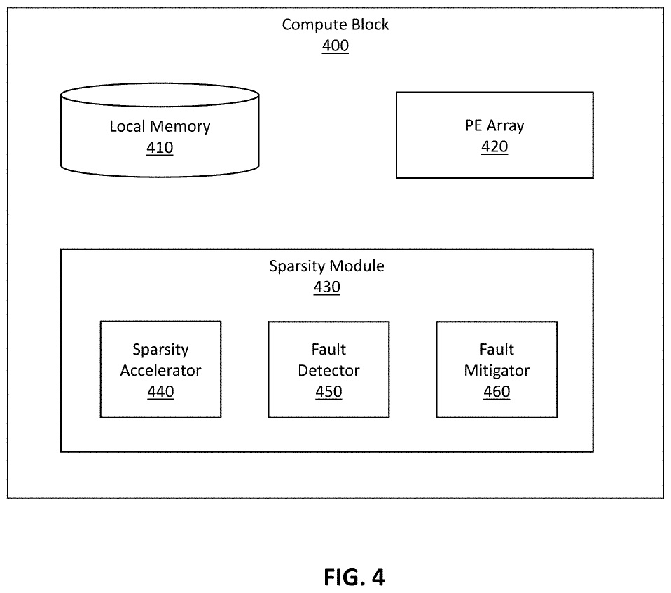

FIG. 4 is a block diagram of a compute block 400, in accordance with various embodiments. The compute block 400 may be an example of the compute block 330 in FIG. 3. As shown in FIG. 4, the compute block 400 includes a local memory 410, a PE array 420, and a sparsity module 430. In other embodiments, alternative configurations, different or additional components may be included in the compute block 400. For instance, the compute block 400 may include more than one local memory 410, PE array 420, or sparsity module 430. Further, functionality attributed to a component of the compute block 400 may be accomplished by a different component included in the compute block 400, another component of the DNN accelerator 300, or by a different system.

The local memory 410 is local to the compute block 400. In the embodiments of FIG. 4, the local memory 410 is inside the compute block 400. In other embodiments, the local memory 410 may be outside the compute block 400. The local memory 410 and the compute block 400 can be implemented on the same chip. The local memory 410 stores data used for or generated from convolutions, e.g., input activations, weights, and output activations. In some embodiments, the local memory 410 includes one or more SRAMs (static random-access memories). The local memory 410 may be byte-addressable, and each memory address identifies a single byte (eight bits) of storage. In some embodiments, the local memory 410 may include banks, each bank may have a capacity of a fixed number of bytes, such as 32, 64, and so on.

The PE array 420 performs MAC operations in convolutions. The PE array 420 may perform other deep learning operations. The PE array 420 may include PEs arranged in columns, or columns and rows. Each PE can perform MAC operations. In some embodiments, a PE includes one or more multipliers for performing multiplications. An PE may also include one or more adders for performing accumulations. A column of PEs is referred to as a PE column. A PE column may be associated with one or more MAC lanes. A MAC lane is a path for loading data into a MAC column. A MAC lane may be also referred to as a data transmission lane or data load lane. APE column may have multiple MAC lanes. The loading bandwidth of the MAC column is an aggregation of the loading bandwidths of all the MAC lanes associated with the MAC column. With a certain number of MAC lanes, data can be fed into the same number of independent PEs simultaneously. In some embodiments where a MAC column has four MAC lanes for feeding activations or weights into the MAC column and each MAC lane may have a bandwidth of 16 bytes, the four MAC lanes can have a total loading bandwidth of 64 bytes.

In some embodiments, the PE array 420 may be capable of standard convolution, depthwise convolution, pointwise convolution, other types of convolutions, or some combination thereof. In a depthwise convolution, a PE may perform an MAC operation that include a sequence of multiplications for an activation operand (e.g., the activation operand 217) and a weight operand (e.g., the weight operand 227). Each multiplication in the sequence is a multiplication of a different activation in the activation operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the PE. The PE array 420 may output multiple output operands at a time, each of which is generated by a different PE. In a standard convolution, MAC operations may include accumulations across the channels. For instance, as opposed to generating an output operand, a PE may accumulate products across different channels to generate a single output point.

In some embodiments, a PE may perform multiple rounds of MAC operations for a convolution. Data (activations, weights, or both) may be reused within a single round, e.g., across different multipliers in the PE, or reused across different rounds of MAC operations. More details regarding PE array are described below in conjunction with FIGS. 5 and 6.

The sparsity module 430 accelerates deep learning operations in DNNs based on sparsity in the input data of the deep learning operations. The sparsity module 430 may have a sparsity acceleration logic that can identify nonzero valued activation-weight pairs and skips zero valued activation-weight pairs. A nonzero valued activation-weight pair includes a nonzero valued activation and a nonzero valued weight, while a zero valued activation-weight pair includes a zero valued activation or a zero valued weight. The sparsity module 430 can also detect and mitigate faults within the sparsity acceleration logic, e.g., control failures or computational errors in the process of identifying nonzero valued activation-weight pairs.

Even though FIG. 4 shows a single sparsity module 430, the compute block 400 may include multiple sparsity modules 430. In some embodiments, every PE in the PE array 420 is implemented with a sparsity module 430 for acceleration computations in the individual PE. In other embodiments, a subset of the PE array 420 (e.g., a PE column or multiple PE columns in the PE array 420) may be implemented with a sparsity module 430 for acceleration computations in the subset of PEs. As shown in FIG. 4, the sparsity module 430 includes a sparsity accelerator 440, a fault detector 450, and a fault mitigator 460. In other embodiments, the sparsity module 430 may include fewer, more, or different components. Also, functionality attributed to one component of the sparsity module 430 may be accomplished by a different component included in the sparsity module 430, a different component in the compute block 400, or a different apparatus than those illustrated.

The sparsity module 430 accelerates computations in the PE array 420 based on sparsity in input data of the computations. In some embodiments (e.g., embodiments where the compute block 400 executes a convolutional layer), a computation in a PE may be a MAC operation on an activation operand and a weight operand. The activation operand may be a portion of the input tensor of the convolution. The activation operand includes a sequence of input elements, aka activations. The activations may be from different input channels. For instance, each activation is from a different input channel from all the other activations in the activation operand. The activation operand is associated with an activation bitmap (also referred to as “activation sparsity vector”), which may be stored in the local memory 410. The activation bitmap can indicate positions of the nonzero valued activations in the activation operand. The activation bitmap may include a sequence of bits, each of which corresponds to a respective activation in the activation operand. The position of a bit in the activation bitmap may match the position of the corresponding activation in the activation operand. A bit in the activation bitmap may be zero or one. A zero valued bit indicates that the value of the corresponding activation is zero, a one valued bit indicates that the value of the corresponding activation is nonzero. In some embodiments, the activation bitmap may be generated during the execution of another DNN layer, e.g., a layer that is arranged before the convolutional layer in the DNN.

The weight operand may be a portion of a kernel of the convolution. The weight operand includes a sequence of weights. The values of the weights are determined through training the DNN. The weights in the weight operand may be from different input channels. For instance, each weight is from a different input channel from all the other weights in the weight operand. The weight operand is associated with a weight bitmap (also referred to as “activation sparsity vector”), which may be stored in the local memory 410. The weight bitmap can indicate positions of the nonzero valued weights in the weight operand. The weight bitmap may include a sequence of bits, each of which corresponds to a respective weight in the weight operand. The position of a bit in the weight bitmap may match the position of the corresponding weight in the weight operand. A bit in the weight bitmap may be zero or one. A zero valued bit indicates that the value of the corresponding weight is zero, a one valued bit indicates that the value of the corresponding weight is nonzero.

The sparsity accelerator 440 may receive the activation bitmap and the weight bitmap and generate a combined sparsity bitmap for the MAC operation to be performed by the PE. In some embodiments, the sparsity accelerator 440 generates the combined sparsity bitmap 735 by performing one or more AND operations on the activation bitmap and the weight bitmap. Each bit in the combined sparsity bitmap is a result of an AND operation on a bit in the activation bitmap and a bit in the weight bitmap, i.e., a product of the bit in the activation bitmap and the bit in the weight bitmap. The position of the bit in the combined sparsity bitmap matches the position of the bit in the activation bitmap and the position of the bit in the weight bitmap. A bit in the combined bitmap corresponds to a pair of activation and weight (activation-weight pair). A zero bit in the combined sparsity bitmap indicates that at least one of the activation and weight in the pair is zero. A one bit in the combined sparsity bitmap indicates that both the activation and weight in the pair are nonzero. The combined sparsity bitmap may be stored in the local memory 410.

The sparsity accelerator 440 may provide activations and weights to the PE based on the combined sparsity bitmap. For instance, the sparsity accelerator 440 may identify one or more nonzero valued activation-weight pairs from the local memory 410 based on the combined sparsity bitmap. The local memory 410 may store activation operands and weight operands in a compressed format so that nonzero valued activations and nonzero valued weights are stored but zero valued activations and zero valued weights are not stored. The nonzero valued activation(s) of an activation operand may constitute a compressed activation operand. The nonzero valued weight (s) of a weight operand may constitute a compressed weight operand. For a nonzero valued activation-weight pair, the sparsity accelerator 440 may determine a position the activation in the compressed activation operand and determine a position of the weight in the compressed weight operand based on the activation bitmap, weight bitmap, and the combined bitmap. The activation and weight can be read from the local memory 410 based on the positions determined by the sparsity accelerator 440.

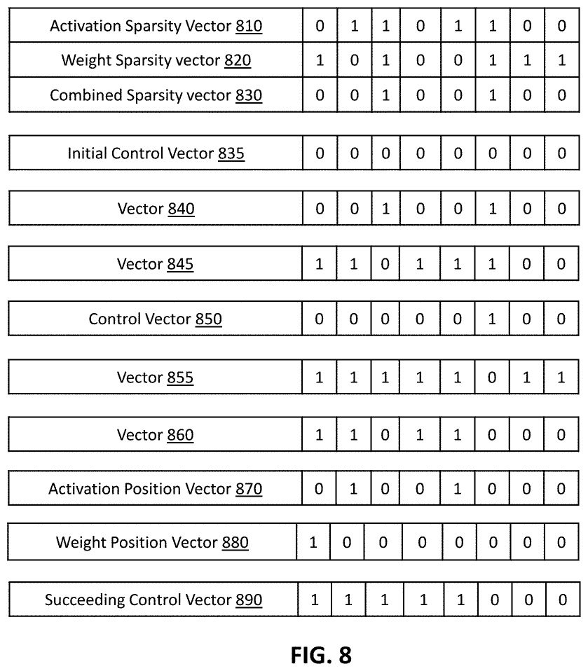

In some embodiments, the sparsity accelerator 440 includes a sparsity acceleration logic that can compute position bitmaps based on the activation bitmap and weight bitmap. The sparsity acceleration 440 may determine position indexes of the activation and weight based on the position bitmaps. In an example, the position index of the activation in the compressed activation operand may equal the number of one(s) in an activation position bitmap generated by the sparsity accelerator 440, and the position index of the weight in the compressed weight operand may equal the number of one(s) in a weight position bitmap generated by the sparsity accelerator 440. The position index of the activation or weight indicates the position of the activation or weight in the compressed activation operand or the compressed weight operand. The sparsity accelerator 440 may read the activation and weight from one or more memories based on their position indexes. More details regarding identifying nonzero valued activation-weight pairs are provided below in conjunction with FIG. 8.

The sparsity accelerator 440 can forward the identified nonzero valued activation-weight pairs to the PE. The sparsity accelerator 440 may skip the other activations and the other weights, as they will not contribute to the result of the MAC operation. In some embodiments, the local memory 310 may store the nonzero valued activations and weights and not store the zero valued activations or weights. The nonzero valued activations and weights may be loaded to one or more register files of the PE, from which the sparsity accelerator 440 may retrieve the activations and weights corresponding to the ones in the combined sparsity bitmap. In some embodiments, the total number of ones in the combined sparsity bitmap equals the total number of activation-weight pairs that will be computed by the PE, while the PE does not compute the other activation-weight pairs. By skipping the activation-weight pairs corresponding to zero bits in the combined sparsity bitmap, the computation of the PE will be faster, compared with the PE computing all the activation-weight pairs in the activation operand and weight operand.

The fault detector 450 detects faults in sparsity computations performed by the sparsity accelerator 440. In some embodiments, the fault detector 450 may detect a control failure in a round of sparsity computation based on a control bitmap computed in the round of sparsity computation. In the process of computing the position bitmaps, the sparsity accelerator 440 may compute one or more intermediate bitmaps based on the activation bitmap and weight bitmap. One of the intermediate bitmaps may be referred to as a control bitmap. The control bitmap may be generated based on an initial control bitmap, which has been generated from the previous round of sparsity computation. Additionally or alternatively, the control bitmap may be used to determine a succeeding control bitmap in the current round, and the succeeding control bitmap can be used as the initial control bitmap for the next round of sparsity computation. That way, the control bitmap can inherit computational information from the previous round of sparsity computation or carry computational information to the next round of sparsity computation.

The fault detector 450 may compute a sum of the number of ones in the control vector with a number, such as one. The fault detector 450 may further compare the sum with the control vector used in a previous round, such as the round that is immediately before the current round. In embodiments where the sum equals the control vector in the previous round, the fault detector 450 determines that there is no control failure, and that the sparsity computation may continue. In embodiments where the sum does not equal the control vector in the previous round, the fault detector 450 determines that there is a control failure.

In some embodiments, the fault detector 450 can also detect computational errors in sparsity computation. A computational error may be an error in a position index determined by the sparsity accelerator 440. The fault detector 450 may determine whether the number of one(s) in the activation position bitmap is greater than the number of one(s) in the activation bitmap. The fault detector 450 may also determine whether the number of one(s) in the weight position bitmap is greater than the number of one(s) in the weight bitmap. In embodiments where either the number of one(s) in the activation position bitmap is greater than the number of one(s) in the activation bitmap or the number of one(s) in the weight position bitmap is greater than the number of one(s) in the weight bitmap, the fault detector 450 determines that there is a computational error. Otherwise, the fault detector 450 determines that there is no computational error.

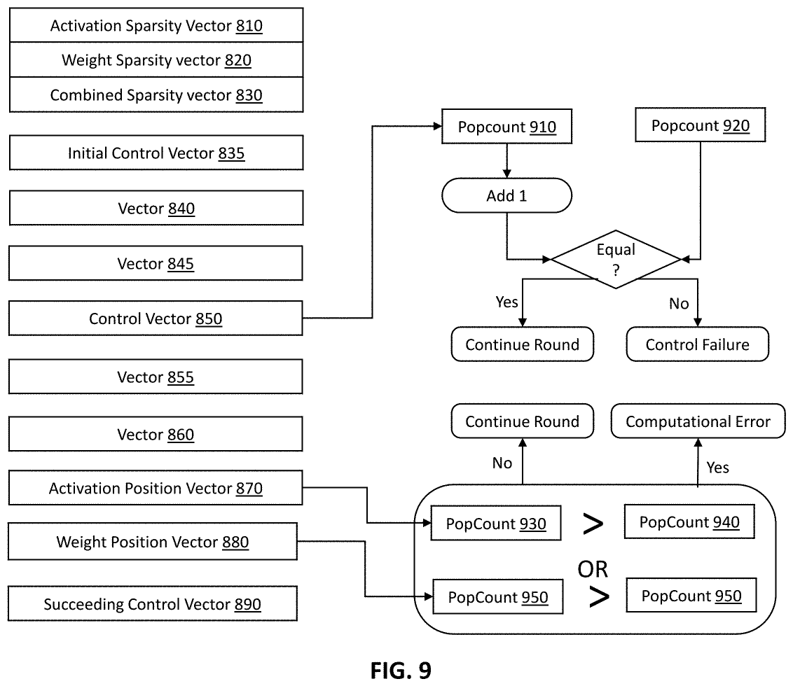

After a fault (e.g., a control failure or a computational error) is detected, the fault detector 450 may instruct the fault mitigator 460 to mitigate the fault. The fault detector 450 may also instruct the sparsity accelerator 440 to pause the sparsity computation till the fault is mitigated. More details regarding fault detections are described below in conjunction with FIG. 9.

The fault mitigator 460 mitigates faults in sparsity computations performed by the sparsity accelerator 440. In some embodiments, the fault mitigator 460 may receive an instruction from the fault detector 450 to mitigate a detected control failure. The fault mitigator 460 may mitigate a control failure based on the control vector from the previous round. The previous round may have no control failure. The fault mitigator 460 may temporarily store the control vector from the previous round, e.g., in a temporary register. The fault mitigator 460 may generate a new control vector based on the control vector from the previous round to replace the control vector based on which the control failure is detected. To generate the new control vector, the fault mitigator 460 may change the last one in the control vector from the previous round to zero. Other bits in the control vector from the previous round may not be changed. The fault mitigator 460 may provide the new control vector to the sparsity accelerator 440, and the sparsity accelerator 440 can continue the sparsity computation using the new control vector. The sparsity accelerator 440 may also generate a succeeding control vector based on the new control vector so that the control failure is not carried to the next round of sparsity computation.

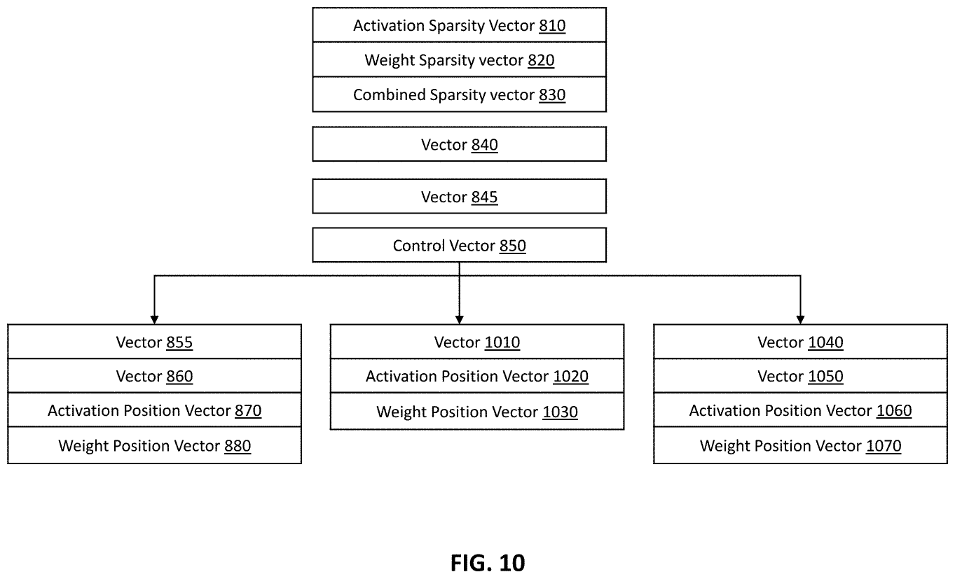

The fault mitigator 460 may receive an instruction from the fault detector 450 to mitigate a detected computational error. In some embodiments, the fault mitigator 460 may use a redundancy approach to mitigate a computational error. For instance, the fault mitigator 460 may provide one or more variations of the sparsity acceleration logic that can run in parallel with the original acceleration logic. That way, multiple sparsity acceleration logics may run simultaneously to identify one nonzero valued activation-weight pair. The sparsity acceleration logics may use the same control vector but compute different intermediate vectors based on the control vector. Each sparsity acceleration logic can output a position index of the activation and a position index of the weight. Position indexes from different sparsity acceleration logics may be the same. The fault mitigator 460 may select the position index determined by most of the sparsity acceleration logics. In an example where five sparsity acceleration logics are used and three sparsity acceleration logics output the same position index of the activation or weight, the fault mitigator 460 may select that position index to identify the activation or weight. More details regarding the redundancy approach for mitigating faults are described below in conjunction with FIG. 10.

The redundancy approach has minimal overhead in terms of time as the different sparsity acceleration logics can run in parallel. Also, the area overhead can be minimal as the sparsity acceleration logics can be implemented with basic gates. The power overhead can be insignificant too. In some embodiments (e.g., embodiments where the computational resource is limited, the deep learning operation is not of paramount importance to the accuracy of the DNN, the accuracy of the DNN is not of paramount importance to the application, etc.), the fault mitigator 460 may use a different approach to mitigate computational errors to further reduce the area or power overhead. In an example, the fault mitigator 460 may prevent identification of an activation or weight after a computational error is detected, so that the activation or weight will not be computed by the PE. The fault mitigator 460 may, instead of using the redundancy approach, identify or instruct the sparsity accelerator 440 to ignore the position index determined from the current round sparsity computation but identify the next activation or weight in the compressed activation operand or compressed weight operand. The next activation or weight in the compressed activation operand or compressed weight operand may be the activation or weight in the compressed activation operand or compressed weight operand that is arranged immediately after the activation or weight identified in the previous round of sparsity computation.

In some embodiments, the fault mitigator 460 may use a dynamic mitigation mechanism to mitigate faults. The fault mitigator may determine whether a fault is transient or permanent. The fault mitigator 460 may count how many times a fault has been detected. In embodiments where the number of times a fault has been detected is above a threshold number, the fault mitigator may determine that the fault is permanent. For a permanent fault, the fault mitigator 460 may deactivate the fault detector 450 so that fault detection will be avoided to save time and energy. It is assumed that a permanent fault will continue to happen so that it is not necessary to keep detecting it. The fault mitigator 460 may keep the fault mitigation mechanism (e.g., the redundancy mechanism) active till the end of the MAC operation, the end of the deep learning operation, or even the end of the DNN inference process. In an example where the detection is deactivated during the DNN inference process, the power savings can be represented as:

$$Power Savings ( \% ) = ( 1 - \frac{M}{N} ) * 100 \%$$

where M is the number of sparsity computation rounds for which the transient fault is manifested, and N is the total number of sparsity computation rounds required by the DNN accelerator to accomplish the inference.

In embodiments where a fault is transient (e.g., the number of times the fault has been detected is below a threshold number), the fault detection may stay active. The fault mitigator may be activated after a fault is detected. The dynamic mitigation approach can save power without significantly sacrificing the performance of the DNN accelerator or the accuracy of the DNN.

FIG. 5 illustrates a PE array 500, in accordance with various embodiments. The PE array 500 may be an embodiment of the PE array 420 in FIG. 4. The PE array 500 includes a plurality of PEs 510 (individually referred to as “PE 510”). The PEs 510 perform MAC operations. The PEs 510 may also be referred to as neurons in the DNN. Each PE 510 has two input signals 550 and 560 and an output signal 570. The input signal 550 is at least a portion of an IFM to the layer. The input signal 560 is at least a portion of a filter of the layer. In some embodiments, the input signal 550 of a PE 510 includes one or more activation operands, and the input signal 560 includes one or more weight operands.

Each PE 510 performs an MAC operation on the input signals 550 and 560 and outputs the output signal 570, which is a result of the MAC operation. Some or all of the input signals 550 and 560 and the output signal 570 may be in an integer format, such as INT8, or floating-point format, such as FP16 or BF16. For purpose of simplicity and illustration, the input signals and output signal of all the PEs 510 have the same reference numbers, but the PEs 510 may receive different input signals and output different output signals from each other. Also, a PE 510 may be different from another PE 510, e.g., including more, fewer, or different components.

As shown in FIG. 5, the PEs 510 are connected to each other, as indicated by the dash arrows in FIG. 5. The output signal 570 of an PE 510 may be sent to many other PEs 510 (and possibly back to itself) as input signals via the interconnections between PEs 510. In some embodiments, the output signal 570 of an PE 510 may incorporate the output signals of one or more other PEs 510 through an accumulate operation of the PE 510 and generates an internal partial sum of the PE array. More details about the PEs 510 are described below in conjunction with FIG. 5B.

In the embodiments of FIG. 5, the PEs 510 are arranged into columns 505 (individually referred to as “column 505”). The input and weights of the layer may be distributed to the PEs 510 based on the columns 505. Each column 505 has a column buffer 520. The column buffer 520 stores data provided to the PEs 510 in the column 505 for a short amount of time. The column buffer 520 may also store data output by the last PE 510 in the column 505. The output of the last PE 510 may be a sum of the MAC operations of all the PEs 510 in the column 505, which is a column-level internal partial sum of the PE array 500. In other embodiments, input and weights may be distributed to the PEs 510 based on rows in the PE array 500. The PE array 500 may include row buffers in lieu of column buffers 520. A row buffer may store input signals of the PEs in the corresponding row and may also store a row-level internal partial sum of the PE array 500.

As shown in FIG. 5, each column buffer 520 is associated with a load 530 and a drain 540. The data provided to the column 505 is transmitted to the column buffer 520 through the load 530, e.g., through upper memory hierarchies, e.g., the local memory 410 in FIG. 4. The data generated by the column 505 is extracted from the column buffers 520 through the drain 540. In some embodiments, data extracted from a column buffer 520 is sent to upper memory hierarchies, e.g., the local memory 410 in FIG. 4, through the drain operation. In some embodiments, the drain operation does not start until all the PEs 510 in the column 505 has finished their MAC operations. In some embodiments, the load 530 or drain 540 may be controlled by the controlling module 340. Even though not shown in FIG. 5, one or more columns 505 may be associated with an external adder assembly.

FIG. 6 is a block diagram of a PE 600, in accordance with various embodiments. The PE 600 may be an embodiment of the PE 510 in FIG. 5. The PE 600 includes input register files 610 (individually referred to as “input register file 610”), weight registers file 620 (individually referred to as “weight register file 620”), multipliers 630 (individually referred to as “multiplier 630”), an internal adder assembly 640, and an output register file 650. In other embodiments, the PE 600 may include fewer, more, or different components. For example, the PE 600 may include multiple output register files 650. As another example, the PE 600 may include a single input register file 610, weight register file 620, or multiplier 630. As yet another example, the PE 600 may include an adder in lieu of the internal adder assembly 640.

The input register files 610 temporarily store activation operands for MAC operations by the PE 600. In some embodiments, an input register file 610 may store a single activation operand at a time. In other embodiments, an input register file 610 may store multiple activation operand or a portion of an activation operand at a time. An activation operand includes a plurality of input elements (i.e., input elements) in an input tensor. The input elements of an activation operand may be stored sequentially in the input register file 610 so the input elements can be processed sequentially. In some embodiments, each input element in the activation operand may be from a different input channel of the input tensor. The activation operand may include an input element from each of the input channels of the input tensor, and the number of input elements in an activation operand may equal the number of the input channels. The input elements in an activation operand may have the same XY coordinates, which may be used as the XY coordinates of the activation operand. For instance, all the input elements of an activation operand may be X0Y0, X0Y1, X1Y1, etc.

The weight register file 620 temporarily stores weight operands for MAC operations by the PE 600. The weight operands include weights in the filters of the DNN layer. In some embodiments, the weight register file 620 may store a single weight operand at a time. other embodiments, an input register file 610 may store multiple weight operands or a portion of a weight operand at a time. A weight operand may include a plurality of weights. The weights of a weight operand may be stored sequentially in the weight register file 620 so the weight can be processed sequentially. In some embodiments, for a multiplication operation that involves a weight operand and an activation operand, each weight in the weight operand may correspond to an input element of the activation operand. The number of weights in the weight operand may equal the number of the input elements in the activation operand.

In some embodiments, a weight register file 620 may be the same or similar as an input register file 610, e.g., having the same size, etc. The PE 600 may include a plurality of register files, some of which are designated as the input register files 610 for storing activation operands, some of which are designated as the weight register files 620 for storing weight operands, and some of which are designated as the output register file 650 for storing output operands. In other embodiments, register files in the PE 600 may be designated for other purposes, e.g., for storing scale operands used in elementwise add operations, etc. The designation of the register files may be controlled by the controlling module 340.

The multipliers 630 perform multiplication operations on activation operands and weight operands. A multiplier 630 may perform a sequence of multiplication operations on a single activation operand and a single weight operand and generates a product operand including a sequence of products. Each multiplication operation in the sequence includes multiplying an input element in the activation operand and a weight in the weight operand. In some embodiments, a position (or index) of the input element in the activation operand matches the position (or index) of the weight in the weight operand. For instance, the first multiplication operation is a multiplication of the first input element in the activation operand and the first weight in the weight operand, the second multiplication operation is a multiplication of the second input element in the activation operand and the second weight in the weight operand, the third multiplication operation is a multiplication of the third input element in the activation operand and the third weight in the weight operand, and so on. The input element and weight in the same multiplication operation may correspond to the same depthwise channel, and their product may also correspond to the same depthwise channel.

Multiple multipliers 630 may perform multiplication operations simultaneously. These multiplication operations may be referred to as a round of multiplication operations. In a round of multiplication operations by the multipliers 630, each of the multipliers 630 may use a different activation operand and a different weight operand. The different activation operands or weight operands may be stored in different register files of the PE 600. For instance, a first multiplier 630 uses a first activation operand (e.g., stored in a first input register file 610) and a first weight operand (e.g., stored in a first weight register file 620), versus a second multiplier 630 uses a second activation operand (e.g., stored in a second input register file 610) and a second weight operand (e.g., stored in a second weight register file 620), a third multiplier 630 uses a third activation operand (e.g., stored in a third input register file 610) and a third weight operand (e.g., stored in a third weight register file 620), and so on. For an individual multiplier 630, the round of multiplication operations may include a plurality of cycles. A cycle includes a multiplication operation on an input element and a weight.

The multipliers 630 may perform multiple rounds of multiplication operations. A multiplier 630 may use the same weight operand but different activation operands in different rounds. For instance, the multiplier 630 performs a sequence of multiplication operations on a first activation operand stored in a first input register file in a first round, versus a second activation operand stored in a second input register file in a second round. In the second round, a different multiplier 630 may use the first activation operand and a different weight operand to perform another sequence of multiplication operations. That way, the first activation operand is reused in the second round. The first activation operand may be further reused in additional rounds, e.g., by additional multipliers 630.

The internal adder assembly 640 includes one or more adders inside the PE 600, i.e., internal adders. The internal adder assembly 640 may perform accumulation operations on two or more products operands from multipliers 630 and produce an output operand of the PE 600. In some embodiments, the internal adders are arranged in a sequence of tiers. A tier includes one or more internal adders. For the first tier of the internal adder assembly 640, an internal adder may receive product operands from two or more multipliers 630 and generate a sum operand through a sequence of accumulation operations. Each accumulation operation produces a sum of two or more products, each of which is from a different multiplier 630. The sum operand includes a sequence of sums, each of which is a result of an accumulation operation and corresponds to a depthwise channel. For the other tier(s) of the internal adder assembly 640, an internal adder in a tier receives sum operands from the precedent tier in the sequence. Each of these number may be generated by a different internal adder in the precedent tier. A ratio of the number of internal adders in a tier to the number of internal adders in a subsequent tier may be 2:1. In some embodiments, the last tier of the internal adder assembly 640 may include a single internal adder, which produces the output operand of the PE 600.

The output register file 650 stores output operands of the PE 600. In some embodiments, the output register file 650 may store an output operand at a time. In other embodiments, the output register file 650 may store multiple output operand or a portion of an output operand at a time. An output operand includes a plurality of output elements in an IFM. The output elements of an output operand may be stored sequentially in the output register file 650 so the output elements can be processed sequentially. In some embodiments, each output element in the output operand corresponds to a different depthwise channel and is an element of a different output channel of the output channel of the depthwise convolution. The number of output element in an output operand may equal the number of the depthwise channels of the depthwise convolution.

Example Sparsity Acceleration in PE

FIG. 7 illustrates sparsity acceleration in an MAC operation by a PE 700, in accordance with various embodiments. The PE 700 may be an example of the PE 510 in FIG. 5. In the embodiments of FIG. 7, the PE 700 includes an input register file 710, a weight register file 720, a multiplier 730, an accumulator 740, and an output register file 750. In other embodiments, the PE 700 may include fewer, more, or different components. The PE 700 is associated with a sparsity module 760. The sparsity module 760 may be an embodiment of the sparsity module 430 in FIG. 4.

The input register file 710 stores at least part of an activation operand. The activation operand includes a sequence of input elements, aka activations. The activation operand may be a portion of an input tensor, e.g., an input tensor of a convolutional layer. The activation operand is associated with an activation bitmap 715. The activation bitmap 715 may be stored in the input register file 710, the local memory of the compute block that includes the PE 700, or both. The activation bitmap 715 can indicate positions of the nonzero valued activations in the activation operand. The activation bitmap 715 includes a sequence of bits, each of which corresponds to a respective activation in the activation operand. In some embodiments, the position of a bit in the activation bitmap 715 matches the position of the corresponding activation in the activation operand. For the purpose of illustration, the activation bitmap 715 includes eight bits, and the activation operand includes eight activations. In other embodiments, the activation bitmap 715 may include fewer or more bits. As shown in FIG. 7, four of the eight bits in the activation bitmap 715 are zero valued, and the other four bits are one valued. A zero valued bit indicates that the value of the corresponding activation is zero, a one valued bit indicates that the value of the corresponding activation is nonzero. Accordingly, the activation operand includes four zero valued activations and four nonzero valued activations.

The weight register file 720 stores at least part of a weight operand. The weight operand includes a sequence of weights. The weight operand may be a portion of a filter, e.g., a filter of a convolutional layer. The weight operand is associated with a weight bitmap 725. The weight bitmap 725 may be stored in the weight register file 720, the local memory of the compute block that includes the PE 700, or both. The weight bitmap 725 can indicate positions of the nonzero valued weights in the weight operand. The weight bitmap 725 includes a sequence of bits, each of which corresponds to a respective weight in the weight operand. In some embodiments, the position of a bit in the weight bitmap 725 matches the position of the corresponding weight in the weight operand. For the purpose of illustration, the weight bitmap 725 includes eight bits, and the weight operand includes eight weights. In other embodiments, the weight bitmap 725 may include fewer or more bits. As shown in FIG. 7, four of the eight bits in the weight bitmap 725 are zero valued, and the other four bits are one valued. A zero valued bit indicates that the value of the corresponding weight is zero, a one valued bit indicates that the value of the corresponding weight is nonzero. Accordingly, the weight operand includes four zero valued weights and four nonzero valued weights. The weight bitmap 725 can indicate positions of the nonzero valued weights in the weight operand.

The sparsity module 760 generates a combined sparsity bitmap 735 based on the activation bitmap 715 and the weight bitmap 725. The sparsity module 760 may receive the activation bitmap 715 from the input register file 710 or the local memory of the compute block that includes the PE 700. The sparsity module 760 may receive the weight bitmap 725 from the weight register file 720 or the local memory of the compute block. In some embodiments, the sparsity module 760 is an AND operator. The sparsity module 760 may generate the combined sparsity bitmap 735 by performing one or more AND operations on the activation bitmap 715 and the weight bitmap 725. Each bit in the combined sparsity bitmap 735 is a result of an AND operation on a bit in the activation bitmap 715 and a bit in the weight bitmap 725. A position of the bit in the combined sparsity bitmap 735 matches the position of the bit in the activation bitmap 715 and the position of the bit in the weight bitmap 725. For instance, the first bit in the combined sparsity bitmap 735 is a result of an AND operation on the first bit in the activation bitmap 715 and the first bit in the weight bitmap 725, the second bit in the combined sparsity bitmap 735 is a result of an AND operation on the second bit in the activation bitmap 715 and the second bit in the weight bitmap 725, the third bit in the combined sparsity bitmap 735 is a result of an AND operation on the third bit in the activation bitmap 715 and the third bit in the weight bitmap 725, and so on.

A bit in the combined sparsity bitmap 735 has a value of one when the corresponding bit in the activation bitmap 715 and the corresponding bit in the weight bitmap 725 both have values of one. When at least one of the corresponding bits in the activation bitmap 715 and the corresponding bit in the weight bitmap 725 has a value of zero, the bit in the combined sparsity bitmap 735 has a value of zero. As shown in FIG. 7, the combined sparsity bitmap 735 includes six zeros and two ones.

The total number of ones in the combined sparsity bitmap 735 equals the total number of nonzero valued activation-weight pairs that will be computed by the PE 700 to compute nonzero valued partial sums. The other activation-weight pairs are zero valued activation-weight pairs and can be skipped for computation without any impact on the output accuracy, as these pairs will result in zero valued partial sums. Accordingly, the workload of the PE 700 in this compute round can be determined based on the total number of ones in the combined sparsity bitmap 735. The amount of time for the computation can also be estimated based on the total number of ones in the combined sparsity bitmap 735. The more ones in the combined sparsity bitmap 735, the higher the workload of the PE 700, and the longer the computation of the PE 700.

In some embodiments, the input register file 710 or the weight register file 720 stores dense data points, e.g., nonzero valued activations or nonzero valued weights. The sparse data points, e.g., zero valued activations or zero valued weights, are not stored in the input register file 710 or the weight register file 720. The dense data points may be compressed and kept adjacent to each other in the input register file 710 or the weight register file 720. The dense data point(s) of an activation operand is a compressed activation operand. The dense data point(s) of a weight operand constitutes a compressed weight operand. The position of the ones in the combined sparsity bitmap 735 cannot indicate the positions of the activations in the compressed activation operand or the positions of the weighs in the compressed weight operand. The sparsity module 760 may perform sparsity computations to determine the positions of the activations in the compressed activation operand and the positions of the weighs in the compressed weight operand. The sparsity module 760 may perform a round of sparsity computation for each of the two nonzero valued activation-weight pairs. In each round of sparsity computation, the sparsity module 760 may compute an activation position bitmap and a weight position bitmap based on the activation bitmap 715, the weight bitmap 725, and the combined sparsity bitmap 735. The position of the activation in the compressed activation operand may be indicated by the number of ones in the activation position bitmap, and the position of the weight in the compressed weight operand may be indicated by the number of ones in the weight position bitmap. In the first round of sparsity computation, an intermediate bitmap may be determined and can be used in the second round to identify the next nonzero valued activation-weight pair.

The sparsity module 760 can read, from the input register file 710 and the weight register file 720, the activations and weights of the nonzero valued activation-weight pairs based on the positions determined through the sparsity computations and provides the activations and weights to the multiplier 730. The multiplier 730 performs multiplication operations on the activations and weights. For instance, the multiplier 730 performs a multiplication operation on the activation and weight in each nonzero valued activation-weight individual pair and outputs a partial sum, i.e., a product of the activation and weight. As there are two activation-weight pairs, the multiplier 730 may perform two multiplication operations sequentially, e.g., based on the positions of the ones in the combined sparsity bitmaps 735. Without the sparsity acceleration, the multiplier 730 would need to perform eight multiplication operations. By reducing the number of multiplication operations from eight to two, the MAC operation in the PE 700 is accelerated. As a DNN accelerator usually performs a large number of MAC operations in the execution of a DNN, the sparsity acceleration can significantly improve the efficiency and performance of the DNN accelerator.

The accumulator 740 receives the two partial sums from the multiplier 730 and accumulates the two partial sums. The result of the accumulation is a PE-level internal partial sum. The PE-level internal partial sum may be stored in the output register file 750. In some embodiments, the accumulator 740 receives one or more PE-level internal partial sums from one or more other PEs. The accumulator 740 can accumulate the one or more PE-level internal partial sums with the PE-level internal partial sum of the PE 700 and store the result of the accumulation (i.e., a multi-PE internal partial sum) in the output register file 750. The one or more other PEs may be in the same column as the PE 700 in a PE array. The multi-PE internal partial sum may be a column-level internal partial sum. In some embodiments, the PE-level internal partial sum of the PE 700 or the multi-PE internal partial sum may be sent to one or more other PEs for further accumulation.

Even though FIG. 7 shows a single multiplier 730, the PE 700 may include multiple multipliers that can perform multiple multiplication operations at the same time. These multipliers can be coupled to an internal adder assembly, e.g., the internal adder assembly 640.

Example Sparsity Acceleration Logic

FIG. 8 illustrates a sparsity computation for identifying a pair of nonzero valued activation and nonzero valued weight, in accordance with various embodiments. The sparsity computation may be performed by the sparsity module 430 (e.g., the sparsity accelerator 440 in the sparsity module 430) in FIG. 4 or the sparsity module 760 in FIG. 7. For the purpose of illustration, the nonzero valued activation is in an activation operand including eight activations, and the nonzero valued weight is in a weight operand including eight weights. In other embodiments, the activation operand or weight operand may include a different number of data points. The activation operand and the weight operand may be used, e.g., by a PE, to perform an MAC operation in a convolution. The activation operand may be part of an input tensor of the convolution. The weigh operand may be part of a filter of the convolution.

The activation operand is associated with an activation sparsity vector 810 including eight elements, each of which corresponds to a respective activation in the activation operand and indicates whether the activation is zero or nonzero. The weight operand is associated with a weight sparsity vector 820 including eight elements, each of which corresponds to a respective weight in the weight operand and indicates whether the weight is zero or nonzero. A combined sparsity vector 830 is generated by performing an AND operation on the activation sparsity vector 810 and the weight sparsity vector 820. Each element in the combined sparsity vector 830 is a product of a corresponding element in the activation sparsity vector 810 and a corresponding element in the weight sparsity vector 820. The position of the element in the combined sparsity vector 830 matches the positions of the corresponding element in the activation sparsity vector 810 and the position of the corresponding element in the weight sparsity vector 820. The combined sparsity vector 830 shows that there are two nonzero valued activation-weight pairs for the MAC operation, as there are two ones in the combined sparsity vector 830. There may be two rounds of sparsity computations needed to identify the activation and weights in the two nonzero valued activation-weight pairs.

An initial control vector 835 is defined for the first round of sparsity computation. The first round of sparsity computation can be used to identify the activation and weight in the first nonzero valued activation-weight pair. The initial control vector 835 includes eight elements. As this is the first round of sparsity computation, the eight elements in the initial control vector 835 are all zero. In other rounds, the initial control vector 835 may be determined in the previous round. A vector 840 is generated by performing an AND operation on the combined sparsity vector 830 and the inverse of the initial control vector 835. The inverse of the initial control vector 835 includes eight elements that are all ones. Another vector 845 is generated by subtracting one from the vector 840. Further, an control vector 850 is generated by performing an AND operation on the vector 840 and the vector 845. A vector 855 is also generated by inverting the control vector 850. A vector 860 is generated by performing an AND operation on the vector 845 and the vector 855.

An activation position vector 870 is generated by performing an AND operation on the activation sparsity vector 810 and the vector 860. The number of ones in the activation position vector 870 is counted, which indicates the position of the activation in the compressed activation operand. Also, a weight position vector 880 is generated by performing an AND operation on the weight sparsity vector 820 and the vector 860. The number of ones in the weight position vector 880 is counted, which indicates the position of the weight in the compressed weight operand. Finally, a succeeding control vector 890 is computed by performing an XOR operation on the vector 840 and the vector 845. The succeeding control vector 890 will be used as the initial control vector in the second round of sparsity computation. The second round of sparsity computation can be used to identify the activation and weight in the second nonzero valued activation-weight pair.

As there are two nonzero valued activation-weight pairs in the embodiments of FIG. 8, the sparsity computations can stop as the second round is finished. In other embodiments, there may be further rounds of sparsity computations to identify more nonzero valued activation-weight pairs. In some embodiments, sparsity computations may end after it is determined that the succeeding control vector 890 has all ones in a specific round. A vector shown in FIG. 8 (e.g., the activation sparsity vector 810, weight sparsity vector 820, combined sparsity vector 830, initial control vector 835, vector 840, vector 845, control vector 845, vector 855, vector 860, activation position vector 870, weight position vector 880, or succeeding control vector 890) may be a bitmap. In embodiments where a vector is a bitmap, each element of the vector may be a bit.

The control vector 850 can be used to detect control failure in the sparsity computation round. The control vector 850 may carry the computational information from the current round of sparsity computation to the next round. The fault manifested in the control vector 850 may not result in an actual control failure, although it may result in degradation of classification accuracy in the DNN accelerator. This provides an opportunity to mitigate the control failure. Other vectors generated in the sparsity computation round may not have the computational information for the round. Alternatively, other vectors generated in the sparsity computation round may lead to an actual control failure before the control failure is detected, making it too late to mitigate the control failure before it eventuates in the DNN accelerator.

Example Fault Detection

FIG. 9 illustrates detection of faults in sparsity computation, in accordance with various embodiments. The detection of the faults may be performed by the sparsity module 430 (e.g., the fault detector 450 in the sparsity module 430) in FIG. 4 or the sparsity module 760 in FIG. 7. For the purpose of illustration, the sparsity computation may be the sparsity computation illustrated in FIG. 8.

A popcount 910 of the control vector 850 in the current round of sparsity computation is determined. The popcount 910 may equal the number of one(s) in the control vector 850. Another popcount 920 is also determined. The popcount 920 may correspond to the control vector in the previous round of sparsity computation. The popcount 920 is compared with the sum of the popcount 910 plus one. In embodiments where the popcount 920 is equal to the sum, no control failure is detected, and the current round of sparsity computation can be continued. For instance, the vector 855, vector 860, activation position vector 870, weight position vector 880, and succeeding control vector 890 can be computed. In embodiments where the popcount 920 is not equal to the sum, a control failure is detected.

After a control failure is detected, the fault mitigator 460 may receive an instruction, e.g., from the fault detector 450, to mitigate the control failure. In some embodiments, the control failure is mitigated based on the control vector from the previous round (“previous control vector”). The previous round may be immediately before the current round. The previous control vector may be stored in a temporary register during the previous round. The fault mitigator 460 may retrieve the previous control vector and replace the last “1” in the previous control vector to “0” to generate a new control vector. The new control vector will be used to compute other vectors (e.g., the vector 855, vector 860, activation position vector 870, weight position vector 880, and succeeding control vector 890) in the current round. By correcting the control vector in the current round, the propagation of the control failure in control vectors of subsequent rounds can be prevented. The degraded accuracy of the DNN can be recovered to some extent.

Computational errors can also be detected. To determine whether there is a computational error in the sparsity computation round, a popcount 930 of the activation position vector 870 is determined. The popcount 930 may equal the number of one(s) in the activation position vector 870. Also, a popcount 940 of the activation sparsity vector 810 is determined. The popcount 940 may equal the number of one(s) in the activation sparsity vector 810. The popcount 930 is compared with the popcount 940. Similarly, a popcount 950 of the weight position vector 880 is determined. The popcount 950 may equal the number of one(s) in the weight position vector 880. Also, a popcount 960 of the weight sparsity vector 820 is determined. The popcount 960 may equal the number of one(s) in the weight sparsity vector 820. The popcount 950 is compared with the popcount 960.

In embodiments where the popcount 930 is not greater than the popcount 940 and the popcount 950 is not greater than the popcount 960, no computational error is detected, and the sparsity computation round may continue. For instance, the succeeding control vector 890 may be determined. Also, the activation identified based on the activation position vector 870 and the weight identified based on the weight position vector 880 can be provided to a PE for an MAC operation. In embodiments where the popcount 930 is greater than the popcount 940 or the popcount 950 is greater than the popcount 960, a computational error is detected. The computational error may be mitigated, e.g., by the fault mitigator 460.

Example Fault Mitigation

FIG. 10 illustrates mitigation of a computational error in sparsity computation, in accordance with various embodiments. The sparsity computation may be at least part of the sparsity computation illustrated in FIG. 8. The computational error may be the computational error detected with the approach illustrated in FIG. 9. The mitigation may be performed by the fault mitigator 460 in FIG. 4. In the embodiments of FIG. 10, the computational error is mitigated by using a redundancy approach, in which three different variations of sparsity acceleration logic are used to separately determine activation position index and weight position index. In other embodiments, a different number of variations of sparsity acceleration logic may be used.

As shown in FIG. 10, the three variations of sparsity acceleration logic all start with the same activation sparsity vector 810, weight sparsity vector 820, vector 840, vector 845, and control vector 850. The three variations of sparsity acceleration logic are different in the rest of the sparsity computation. The first variation is the sparsity computation shown in FIG. 8 and generates the vector 855, vector 860, activation position vector 870, and weight position vector 880. The position index of the activation in the compressed activation operand is equal to the number of one(s) in the activation position vector 870. The position index of the weight in the compressed weight operand is equal to the number of one(s) in the weight position vector 880.

Different from the first variation, the second variation computes a vector 1010, e.g., through an OR operation on the control vector 850 and the inverse of the vector 845. Further, an activation position vector 1020 is generated by performing an OR operation on the vector 1010 and the inverse of the activation sparsity vector 810. Also, a weight position vector 1030 is generated by performing an OR operation on the vector 1010 and the inverse of the weight sparsity vector 820. The position index of the activation in the compressed activation operand is equal to the number of zero(s) in the activation position vector 1020. The position index of the weight in the compressed weight operand is equal to the number of zero(s) in the weight position vector 1030.

The third variation is different from the first variation and the second variation. The third variation includes an AND operation on the activation sparsity vector 810 and the vector 845, which generates a vector 1040. A vector 1050 is generated through an AND operation on the weight sparsity vector 820 and the vector 845. Further, an activation position vector 1060 is generated by performing an XOR operation on the control vector 850 and the vector 1040. Also, a weight position vector 1030 is generated by performing an XOR operation on the control vector 850 and the vector 1050. The position index of the activation in the compressed activation operand is equal to the number of zero(s) in the activation position vector 1060. The position index of the weight in the compressed weight operand is equal to the number of zero(s) in the weight position vector 1070.

The three variations may be conducted simultaneously to avoid extra time consumption. The final position of the activation is determined based on the three position indexes of the activation that are output from the three variations. In some embodiments, two or all the three position indexes may match. The position index that has the most votes, i.e., the position index output by the most variations, may be selected and used to identify the activation. Similarly, the final position of the weight is determined based on the three position indexes of the weight that are output from the three variations. In some embodiments, two or all the three position indexes may match. The position index that has the most votes, i.e., the position index output by the most variations, may be selected and used to identify the weight.

The mitigation can reduce or even eliminate the degradation in the accuracy of a DNN run by the DNN accelerator, even with circuit-level faults. Such a redundancy approach has minimal overhead in terms of time, power, and area. The addition of extra variations of sparsity acceleration logic does not add extra computation cycle to the sparsity logic, as all the variations are conducted in parallel. The variations of sparsity acceleration logic can be implemented with logic gates, which are not hard or expensive to implement in hardware. Therefore, the redundancy approach can provide an effective solution to mitigate computational errors in sparsity computations without significantly impairing the performance of the DNN accelerator.

Example Method of Detecting Faults in Sparsity Computations

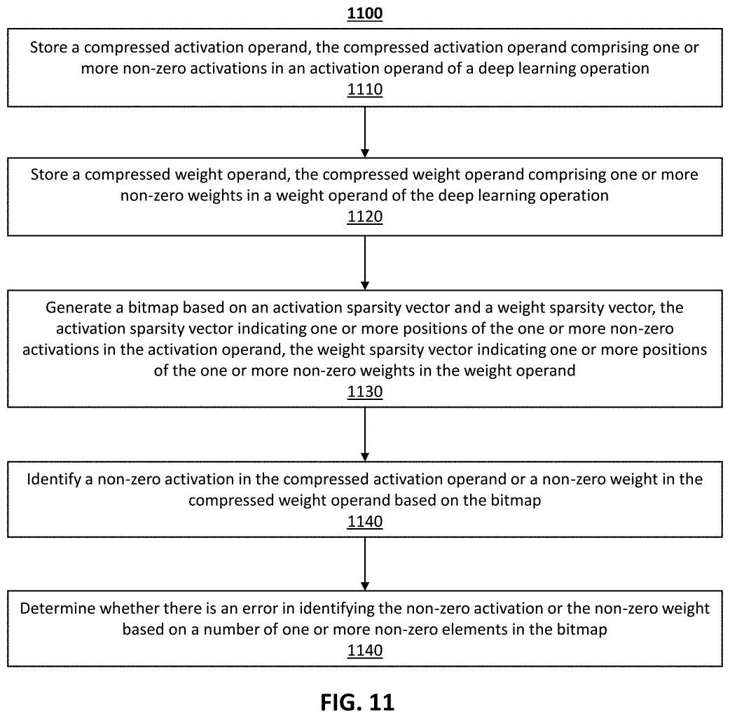

FIG. 11 is a flowchart showing a method 1100 of detecting faults in sparsity computations, in accordance with various embodiments. The method 1100 may be performed by the sparsity module 430 in FIG. 4. Although the method 1100 is described with reference to the flowchart illustrated in FIG. 11, many other methods for detecting faults in sparsity computations may alternatively be used. For example, the order of execution of the steps in FIG. 11 may be changed. As another example, some of the steps may be changed, eliminated, or combined.

The sparsity module 430 stores 1110 a compressed activation operand. The compressed activation operand comprises one or more nonzero valued activations in an activation operand of a deep learning operation. The compressed activation operand may be stored in a local memory, such as the local memory 410 or one or more registered files in a PE array. The activation operand also includes one or more zero valued activations, which may not be stored in the local memory or registered file(s).

The sparsity module 430 stores 1120 a compressed weight operand. The compressed weight operand comprises one or more nonzero valued weights in a weight operand of the deep learning operation. The compressed weight operand may be stored in a local memory, such as the local memory 410 or one or more registered files in a PE array. The weight operand also includes one or more zero valued weight s, which may not be stored in the local memory or registered file(s).

The sparsity module 430 generates 1130 a bitmap based on an activation sparsity vector and a weight sparsity vector. The activation sparsity vector indicates one or more positions of the one or more nonzero valued activations in the activation operand. The weight sparsity vector indicates one or more positions of the one or more nonzero valued weights in the weight operand. In some embodiments, the bitmap is generated based on a previous bitmap. Another nonzero valued activation in the compressed activation operand or another nonzero valued weight in the compressed weight operand was identified based on the previous bitmap.

The sparsity module 430 identifies 1140 a nonzero valued activation in the compressed activation operand or a nonzero valued weight in the compressed weight operand based on the bitmap. In some embodiments, the sparsity module 430 determines a position of the nonzero valued activation in the compressed activation operand. The sparsity module 430 determines a position of the nonzero valued weight in the compressed weight operand. The nonzero valued activation is multiplied with the nonzero valued weight in the deep learning operation.

The sparsity module 430 determines 1150 whether there is a fault in identifying the nonzero valued activation or the nonzero valued weight based on a number of one or more nonzero elements in the bitmap. In an embodiment, the sparsity module 430 determines a number of one or more nonzero elements in a previous bitmap. The sparsity module 430 determines whether the number of one or more nonzero elements in the bitmap is not equal to a sum of one plus the number of one or more nonzero elements in the previous bitmap. In another embodiment, the sparsity module 430 determines whether the number of one or more nonzero elements in the bitmap is greater than a number of the one or more nonzero valued activations in the activation operand. In yet another embodiment, the sparsity module 430 determines whether the number of one or more nonzero elements in the bitmap is greater than a number of the one or more nonzero valued weights in the weight operand.

In an embodiment, after determining that there is a fault in identifying the nonzero valued activation or the nonzero valued weight, the sparsity module 430 generates a new bitmap based on the previous bitmap, e.g., by replacing a nonzero element in the previous bitmap with zero. The sparsity module 430 identifies the nonzero valued activation in the compressed activation operand or the nonzero valued weight in the compressed weight operand based on the new bitmap.

In another embodiment, after determining that there is a fault in identifying the nonzero valued activation, the sparsity module 430 generates a first bitmap and a second bitmap based on the activation sparsity vector and the weight sparsity vector. The sparsity module 430 determines a position of the nonzero valued activation in the compressed activation operand based on the bitmap. The sparsity module 430 determines a first position of the nonzero valued activation in the compressed activation operand based on the first bitmap. The sparsity module 430 determines a second position of the nonzero valued activation in the compressed activation operand based on the second bitmap. The sparsity module 430 identifies the nonzero valued activation in the compressed activation operand based on the position, the first position, and the second position.

In yet another embodiment, after determining that there is a fault in identifying the nonzero valued weight, the sparsity module 430 generates a first bitmap and a second bitmap based on the weight sparsity vector and the weight sparsity vector. The sparsity module 430 determines a position of the nonzero valued weight in the compressed weight operand based on the bitmap. The sparsity module 430 determines a first position of the nonzero valued weight in the compressed weight operand based on the first bitmap. The sparsity module 430 determines a second position of the nonzero valued weight in the compressed weight operand based on the second bitmap. The sparsity module 430 identifies the nonzero valued weight in the compressed weight operand based on the position, the first position, and the second position.

In yet another embodiment, after determining that there is a fault in identifying the nonzero valued activation or the nonzero valued weight, the sparsity module 430 generates a new bitmap based on the previous bitmap. The sparsity module 430 identifies another nonzero valued activation in the compressed activation operand. The another nonzero valued activation is subsequently next to a previously identified nonzero valued activation in the compressed activation operand.

Example Computing Device

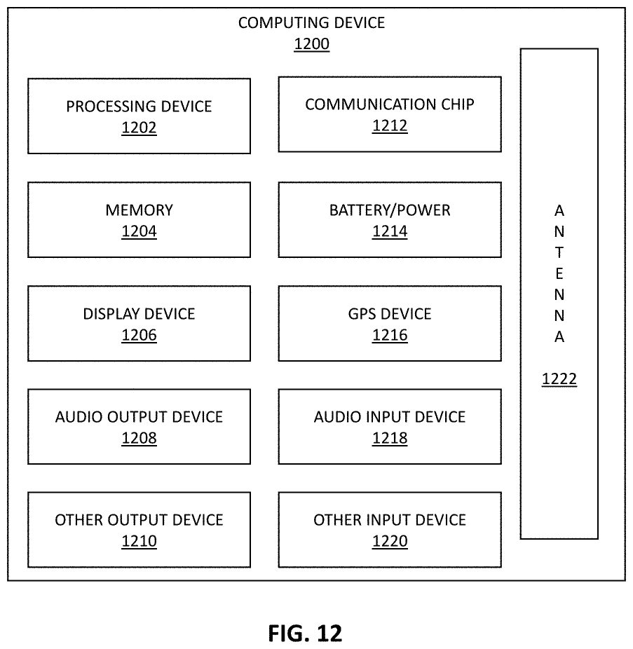

FIG. 12 is a block diagram of an example computing device 1200, in accordance with various embodiments. In some embodiments, the computing device 1200 may be used as at least part of the DNN accelerator 300 in FIG. 3. A number of components are illustrated in FIG. 12 as included in the computing device 1200, but any one or more of these components may be omitted or duplicated, as suitable for the application. In some embodiments, some or all of the components included in the computing device 1200 may be attached to one or more motherboards. In some embodiments, some or all of these components are fabricated onto a single system on a chip (SoC) die. Additionally, in various embodiments, the computing device 1200 may not include one or more of the components illustrated in FIG. 12, but the computing device 1200 may include interface circuitry for coupling to the one or more components. For example, the computing device 1200 may not include a display device 1206, but may include display device interface circuitry (e.g., a connector and driver circuitry) to which a display device 1206 may be coupled. In another set of examples, the computing device 1200 may not include an audio input device 1218 or an audio output device 1208, but may include audio input or output device interface circuitry (e.g., connectors and supporting circuitry) to which an audio input device 1218 or audio output device 1208 may be coupled.

The computing device 1200 may include a processing device 1202 (e.g., one or more processing devices). The processing device 1202 processes electronic data from registers and/or memory to transform that electronic data into other electronic data that may be stored in registers and/or memory. The computing device 1200 may include a memory 1204, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1204 may include memory that shares a die with the processing device 1202. In some embodiments, the memory 1204 includes one or more non-transitory computer-readable media storing instructions executable to perform operations for detecting and mitigating faults in sparsity computations in DNNs, e.g., the method 1100 described above in conjunction with FIG. 11 or some operations performed by the sparsity module 430 described above in conjunction with FIG. 4. The instructions stored in the one or more non-transitory computer-readable media may be executed by the processing device 1202.

In some embodiments, the computing device 1200 may include a communication chip 1212 (e.g., one or more communication chips). For example, the communication chip 1212 may be configured for managing wireless communications for the transfer of data to and from the computing device 1200. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 1212 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1212 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1212 may operate in accordance with other wireless protocols in other embodiments. The computing device 1200 may include an antenna 1222 to facilitate wireless communications and/or to receive other wireless communications (such as AM or FM radio transmissions).

In some embodiments, the communication chip 1212 may manage wired communications, such as electrical, optical, or any other suitable communication protocols (e.g., the Ethernet). As noted above, the communication chip 1212 may include multiple communication chips. For instance, a first communication chip 1212 may be dedicated to shorter-range wireless communications such as Wi-Fi or Bluetooth, and a second communication chip 1212 may be dedicated to longer-range wireless communications such as global positioning system (GPS), EDGE, GPRS, CDMA, WiMAX, LTE, EV-DO, or others. In some embodiments, a first communication chip 1212 may be dedicated to wireless communications, and a second communication chip 1212 may be dedicated to wired communications.

The computing device 1200 may include battery/power circuitry 1214. The battery/power circuitry 1214 may include one or more energy storage devices (e.g., batteries or capacitors) and/or circuitry for coupling components of the computing device 1200 to an energy source separate from the computing device 1200 (e.g., AC line power).

The computing device 1200 may include a display device 1206 (or corresponding interface circuitry, as discussed above). The display device 1206 may include any visual indicators, such as a heads-up display, a computer monitor, a projector, a touchscreen display, a liquid crystal display (LCD), a light-emitting diode display, or a flat panel display, for example.

The computing device 1200 may include an audio output device 1208 (or corresponding interface circuitry, as discussed above). The audio output device 1208 may include any device that generates an audible indicator, such as speakers, headsets, or earbuds, for example.

The computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

The computing device 1200 may include a GPS device 1216 (or corresponding interface circuitry, as discussed above). The GPS device 1216 may be in communication with a satellite-based system and may receive a location of the computing device 1200, as known in the art.

The computing device 1200 may include another output device 1210 (or corresponding interface circuitry, as discussed above). Examples of the other output device 1210 may include an audio codec, a video codec, a printer, a wired or wireless transmitter for providing information to other devices, or an additional storage device.

The computing device 1200 may include another input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1200 may have any desired form factor, such as a handheld or mobile computer system (e.g., a cell phone, a smart phone, a mobile internet device, a music player, a tablet computer, a laptop computer, a netbook computer, an ultrabook computer, a PDA (personal digital assistant), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1200 may be any other electronic device that processes data.

### Select Examples

The following paragraphs provide various examples of the embodiments disclosed herein.

Example 1 provides a method for deep learning, including storing a compressed activation operand and a compressed weight operand, the compressed activation operand comprising one or more nonzero valued activations in an activation operand of a deep learning operation, the compressed weight operand comprising one or more nonzero valued weights in a weight operand of the deep learning operation; generating a bitmap based on an activation sparsity vector and a weight sparsity vector, the activation sparsity vector indicating one or more positions of the one or more nonzero valued activations in the activation operand, the weight sparsity vector indicating one or more positions of the one or more nonzero valued weights in the weight operand; identifying a nonzero valued activation in the compressed activation operand or a nonzero valued weight in the compressed weight operand based on the bitmap; and determining whether there is a fault in identifying the nonzero valued activation or the nonzero valued weight based on a number of one or more nonzero elements in the bitmap.

Example 2 provides the method of example 1, where the bitmap is generated based on a previous bitmap, another nonzero valued activation in the compressed activation operand or another nonzero valued weight in the compressed weight operand was identified based on the previous bitmap, and determining whether there is a fault in identifying the nonzero valued activation or the nonzero valued weight includes determining a number of one or more nonzero elements in the previous bitmap; and determining whether the number of one or more nonzero elements in the bitmap is not equal to a sum of one plus the number of one or more nonzero elements in the previous bitmap.

Example 3 provides the method of example 2, where identifying the nonzero valued activation in the compressed activation operand includes after determining that there is a fault in identifying the nonzero valued activation or the nonzero valued weight, generating a new bitmap based on the previous bitmap; and identifying the nonzero valued activation in the compressed activation operand or the nonzero valued weight in the compressed weight operand based on the new bitmap.

Example 4 provides the method of example 3, where generating the new bitmap based on the previous bitmap includes replacing a nonzero element in the previous bitmap with zero.

Example 5 provides the method of any of the preceding examples, where determining whether there is a fault in identifying the nonzero valued activation or the nonzero valued weight includes determining whether the number of one or more nonzero elements in the bitmap is greater than a number of the one or more nonzero valued activations in the activation operand.

Example 6 provides the method of any of the preceding examples, where determining whether there is a fault in identifying the nonzero valued activation or the nonzero valued weight includes determining whether the number of one or more nonzero elements in the bitmap is greater than a number of the one or more nonzero valued weights in the weight operand.

Example 7 provides the method of any of the preceding examples, where identifying the nonzero valued activation in the compressed activation operand includes after determining that there is a fault in identifying the nonzero valued activation, generating a first bitmap and a second bitmap based on the activation sparsity vector and the weight sparsity vector; determining a position of the nonzero valued activation in the compressed activation operand based on the bitmap; determining a first position of the nonzero valued activation in the compressed activation operand based on the first bitmap; determining a second position of the nonzero valued activation in the compressed activation operand based on the second bitmap; and identifying the nonzero valued activation in the compressed activation operand based on the position, the first position, and the second position.

Example 8 provides the method of any of the preceding examples, where identify the nonzero valued weight in the compressed weight operand includes after determining that there is a fault in identifying the nonzero valued weight, generating a first bitmap and a second bitmap based on the activation sparsity vector and the weight sparsity vector; determining a position of the nonzero valued weight in the compressed weight operand based on the bitmap; determining a first position of the nonzero valued weight in the compressed weight operand based on the first bitmap; determining a second position of the nonzero valued weight in the compressed weight operand based on the second bitmap; and identifying the nonzero valued weight in the compressed weight operand based on the position, the first position, and the second position.

Example 9 provides the method of any of the preceding examples, where identifying the nonzero valued activation in the compressed activation operand includes after determining that there is a fault in identifying the nonzero valued activation, identifying another nonzero valued activation in the compressed activation operand, wherein the another nonzero valued activation is subsequently next to a previously identified nonzero valued activation in the compressed activation operand.

Example 10 provides the method of any of the preceding examples, where identifying the nonzero valued activation in the compressed activation operand or the nonzero valued weight in the compressed weight operand includes determining a position of the nonzero valued activation in the compressed activation operand; and determining a position of the nonzero valued weight in the compressed weight operand, where the nonzero valued activation is multiplied with the nonzero valued weight in the deep learning operation.

Example 11 provides one or more non-transitory computer-readable media storing instructions executable to perform operations for in-network computing, the operations including storing a compressed activation operand and a compressed weight operand, the compressed activation operand comprising one or more nonzero valued activations in an activation operand of a deep learning operation, the compressed weight operand comprising one or more nonzero valued weights in a weight operand of the deep learning operation; generating a bitmap based on an activation sparsity vector and a weight sparsity vector, the activation sparsity vector indicating one or more positions of the one or more nonzero valued activations in the activation operand, the weight sparsity vector indicating one or more positions of the one or more nonzero valued weights in the weight operand; identifying a nonzero valued activation in the compressed activation operand or a nonzero valued weight in the compressed weight operand based on the bitmap; and determining whether there is a fault in identifying the nonzero valued activation or the nonzero valued weight based on a number of one or more nonzero elements in the bitmap.

Example 12 provides the one or more non-transitory computer-readable media of example 11, where the bitmap is generated based on a previous bitmap, another nonzero valued activation in the compressed activation operand or another nonzero valued weight in the compressed weight operand was identified based on the previous bitmap, and determining whether there is a fault in identifying the nonzero valued activation or the nonzero valued weight includes determining a number of one or more nonzero elements in the previous bitmap; and determining whether the number of one or more nonzero elements in the bitmap is not equal to a sum of one plus the number of one or more nonzero elements in the previous bitmap.

Example 13 provides the one or more non-transitory computer-readable media of example 11 or 12, where determining whether there is a fault in identifying the nonzero valued activation or the nonzero valued weight includes determining whether the number of one or more nonzero elements in the bitmap is greater than a number of the one or more nonzero valued activations in the activation operand.

Example 14 provides the one or more non-transitory computer-readable media of any one of examples 11-13, where determining whether there is a fault in identifying the nonzero valued activation or the nonzero valued weight includes determining whether the number of one or more nonzero elements in the bitmap is greater than a number of the one or more nonzero valued weights in the weight operand.

Example 15 provides the one or more non-transitory computer-readable media of any one of examples 11-14, where identifying the nonzero valued activation in the compressed activation operand includes after determining that there is a fault in identifying the nonzero valued activation, generating a first bitmap and a second bitmap based on the activation sparsity vector and the weight sparsity vector; determining a position of the nonzero valued activation in the compressed activation operand based on the bitmap; determining a first position of the nonzero valued activation in the compressed activation operand based on the first bitmap; determining a second position of the nonzero valued activation in the compressed activation operand based on the second bitmap; and identifying the nonzero valued activation in the compressed activation operand based on the position, the first position, and the second position.

Example 16 provides the one or more non-transitory computer-readable media of any one of examples 11-15, where identifying the nonzero valued activation in the compressed activation operand includes after determining that there is a fault in identifying the nonzero valued activation, identifying another nonzero valued activation in the compressed activation operand, wherein the another nonzero valued activation is subsequently next to a previously identified nonzero valued activation in the compressed activation operand.

Example 17 provides an apparatus, including a computer processor for executing computer program instructions; and a non-transitory computer-readable memory storing computer program instructions executable by the computer processor to perform operations including storing a compressed activation operand and a compressed weight operand, the compressed activation operand comprising one or more nonzero valued activations in an activation operand of a deep learning operation, the compressed weight operand comprising one or more nonzero valued weights in a weight operand of the deep learning operation, generating a bitmap based on an activation sparsity vector and a weight sparsity vector, the activation sparsity vector indicating one or more positions of the one or more nonzero valued activations in the activation operand, the weight sparsity vector indicating one or more positions of the one or more nonzero valued weights in the weight operand, identifying a nonzero valued activation in the compressed activation operand or a nonzero valued weight in the compressed weight operand based on the bitmap, and determining whether there is a fault in identifying the nonzero valued activation or the nonzero valued weight based on a number of one or more nonzero elements in the bitmap.

Example 18 provides the apparatus of example 17, where the bitmap is generated based on a previous bitmap, another nonzero valued activation in the compressed activation operand or another nonzero valued weight in the compressed weight operand was identified based on the previous bitmap, and determining whether there is a fault in identifying the nonzero valued activation or the nonzero valued weight includes determining a number of one or more nonzero elements in the previous bitmap; and determining whether the number of one or more nonzero elements in the bitmap is not equal to a sum of one plus the number of one or more nonzero elements in the previous bitmap.

Example 19 provides the apparatus of example 17 or 18, where determining whether there is a fault in identifying the nonzero valued activation or the nonzero valued weight includes determining whether the number of one or more nonzero elements in the bitmap is greater than a number of the one or more nonzero valued activations in the activation operand.

Example 20 provides the apparatus of any one of examples 17-19, where identifying the nonzero valued activation in the compressed activation operand includes after determining that there is a fault in identifying the nonzero valued activation, generating a first bitmap and a second bitmap based on the activation sparsity vector and the weight sparsity vector; determining a position of the nonzero valued activation in the compressed activation operand based on the bitmap; determining a first position of the nonzero valued activation in the compressed activation operand based on the first bitmap; determining a second position of the nonzero valued activation in the compressed activation operand based on the second bitmap; and identifying the nonzero valued activation in the compressed activation operand based on the position, the first position, and the second position.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method for deep learning, comprising:
storing a compressed activation operand and a compressed weight operand, the compressed activation operand comprising one or more nonzero valued activations in an activation operand of a deep learning operation, the compressed weight operand comprising one or more nonzero valued weights in a weight operand of the deep learning operation;
generating a bitmap based on an activation sparsity vector and a weight sparsity vector, the activation sparsity vector indicating one or more positions of the one or more nonzero valued activations in the activation operand, the weight sparsity vector indicating one or more positions of the one or more nonzero valued weights in the weight operand;
identifying a nonzero valued activation in the compressed activation operand or a nonzero valued weight in the compressed weight operand based on the bitmap; and
determining whether there is a fault in identifying the nonzero valued activation or the nonzero valued weight based on a number of one or more nonzero elements in the bitmap.

2. The method of claim 1, wherein the bitmap is generated based on a previous bitmap, another nonzero valued activation in the compressed activation operand or another nonzero valued weight in the compressed weight operand was identified based on the previous bitmap, and determining whether there is a fault in identifying the nonzero valued activation or the nonzero valued weight comprises:
determining a number of one or more nonzero elements in the previous bitmap; and
determining whether the number of one or more nonzero elements in the bitmap is not equal to a sum of one plus the number of one or more nonzero elements in the previous bitmap.

3. The method of claim 2, wherein identifying the nonzero valued activation in the compressed activation operand comprises:
after determining that there is a fault in identifying the nonzero valued activation or the nonzero valued weight, generating a new bitmap based on the previous bitmap; and
identifying the nonzero valued activation in the compressed activation operand or the nonzero valued weight in the compressed weight operand based on the new bitmap.

4. The method of claim 3, wherein generating the new bitmap based on the previous bitmap comprises:
replacing a nonzero element in the previous bitmap with zero.

5. The method of claim 1, wherein determining whether there is a fault in identifying the nonzero valued activation or the nonzero valued weight comprises:
determining whether the number of one or more nonzero elements in the bitmap is greater than a number of the one or more nonzero valued activations in the activation operand.

6. The method of claim 1, wherein determining whether there is a fault in identifying the nonzero valued activation or the nonzero valued weight comprises:
determining whether the number of one or more nonzero elements in the bitmap is greater than a number of the one or more nonzero valued weights in the weight operand.

7. The method of claim 1, wherein identifying the nonzero valued activation in the compressed activation operand comprises:
after determining that there is a fault in identifying the nonzero valued activation, generating a first bitmap and a second bitmap based on the activation sparsity vector and the weight sparsity vector;
determining a position of the nonzero valued activation in the compressed activation operand based on the bitmap;
determining a first position of the nonzero valued activation in the compressed activation operand based on the first bitmap;
determining a second position of the nonzero valued activation in the compressed activation operand based on the second bitmap; and
identifying the nonzero valued activation in the compressed activation operand based on the position, the first position, and the second position.

8. The method of claim 1, wherein identify the nonzero valued weight in the compressed weight operand comprises:
after determining that there is a fault in identifying the nonzero valued weight, generating a first bitmap and a second bitmap based on the activation sparsity vector and the weight sparsity vector;
determining a position of the nonzero valued weight in the compressed weight operand based on the bitmap;
determining a first position of the nonzero valued weight in the compressed weight operand based on the first bitmap;
determining a second position of the nonzero valued weight in the compressed weight operand based on the second bitmap; and
identifying the nonzero valued weight in the compressed weight operand based on the position, the first position, and the second position.

9. The method of claim 1, wherein identifying the nonzero valued activation in the compressed activation operand comprises:
after determining that there is a fault in identifying the nonzero valued activation, identifying another nonzero valued activation in the compressed activation operand, wherein the another nonzero valued activation is subsequently next to a previously identified nonzero valued activation in the compressed activation operand.

10. The method of claim 1, wherein identifying the nonzero valued activation in the compressed activation operand or the nonzero valued weight in the compressed weight operand comprises:
determining a position of the nonzero valued activation in the compressed activation operand; and
determining a position of the nonzero valued weight in the compressed weight operand,
wherein the nonzero valued activation is multiplied with the nonzero valued weight in the deep learning operation.

11. One or more non-transitory computer-readable media storing instructions executable to perform operations for in-network computing, the operations comprising:
storing a compressed activation operand and a compressed weight operand, the compressed activation operand comprising one or more nonzero valued activations in an activation operand of a deep learning operation, the compressed weight operand comprising one or more nonzero valued weights in a weight operand of the deep learning operation;
generating a bitmap based on an activation sparsity vector and a weight sparsity vector, the activation sparsity vector indicating one or more positions of the one or more nonzero valued activations in the activation operand, the weight sparsity vector indicating one or more positions of the one or more nonzero valued weights in the weight operand;
identifying a nonzero valued activation in the compressed activation operand or a nonzero valued weight in the compressed weight operand based on the bitmap; and
determining whether there is a fault in identifying the nonzero valued activation or the nonzero valued weight based on a number of one or more nonzero elements in the bitmap.

12. The one or more non-transitory computer-readable media of claim 11, wherein the bitmap is generated based on a previous bitmap, another nonzero valued activation in the compressed activation operand or another nonzero valued weight in the compressed weight operand was identified based on the previous bitmap, and determining whether there is a fault in identifying the nonzero valued activation or the nonzero valued weight comprises:
determining a number of one or more nonzero elements in the previous bitmap; and
determining whether the number of one or more nonzero elements in the bitmap is not equal to a sum of one plus the number of one or more nonzero elements in the previous bitmap.

13. The one or more non-transitory computer-readable media of claim 11, wherein determining whether there is a fault in identifying the nonzero valued activation or the nonzero valued weight comprises:
determining whether the number of one or more nonzero elements in the bitmap is greater than a number of the one or more nonzero valued activations in the activation operand.

14. The one or more non-transitory computer-readable media of claim 11, wherein determining whether there is a fault in identifying the nonzero valued activation or the nonzero valued weight comprises:
determining whether the number of one or more nonzero elements in the bitmap is greater than a number of the one or more nonzero valued weights in the weight operand.

15. The one or more non-transitory computer-readable media of claim 11, wherein identifying the nonzero valued activation in the compressed activation operand comprises:
after determining that there is a fault in identifying the nonzero valued activation, generating a first bitmap and a second bitmap based on the activation sparsity vector and the weight sparsity vector;
determining a position of the nonzero valued activation in the compressed activation operand based on the bitmap;
determining a first position of the nonzero valued activation in the compressed activation operand based on the first bitmap;
determining a second position of the nonzero valued activation in the compressed activation operand based on the second bitmap; and
identifying the nonzero valued activation in the compressed activation operand based on the position, the first position, and the second position.

16. The one or more non-transitory computer-readable media of claim 11, wherein identifying the nonzero valued activation in the compressed activation operand comprises:
after determining that there is a fault in identifying the nonzero valued activation, identifying another nonzero valued activation in the compressed activation operand, wherein the another nonzero valued activation is subsequently next to a previously identified nonzero valued activation in the compressed activation operand.

17. An apparatus, comprising:
a computer processor for executing computer program instructions; and
a non-transitory computer-readable memory storing computer program instructions executable by the computer processor to perform operations comprising:
storing a compressed activation operand and a compressed weight operand, the compressed activation operand comprising one or more nonzero valued activations in an activation operand of a deep learning operation, the compressed weight operand comprising one or more nonzero valued weights in a weight operand of the deep learning operation,
generating a bitmap based on an activation sparsity vector and a weight sparsity vector, the activation sparsity vector indicating one or more positions of the one or more nonzero valued activations in the activation operand, the weight sparsity vector indicating one or more positions of the one or more nonzero valued weights in the weight operand,
identifying a nonzero valued activation in the compressed activation operand or a nonzero valued weight in the compressed weight operand based on the bitmap, and
determining whether there is a fault in identifying the nonzero valued activation or the nonzero valued weight based on a number of one or more nonzero elements in the bitmap.

18. The apparatus of claim 17, wherein the bitmap is generated based on a previous bitmap, another nonzero valued activation in the compressed activation operand or another nonzero valued weight in the compressed weight operand was identified based on the previous bitmap, and determining whether there is a fault in identifying the nonzero valued activation or the nonzero valued weight comprises:
determining a number of one or more nonzero elements in the previous bitmap; and determining whether the number of one or more nonzero elements in the bitmap is not equal to a sum of one plus the number of one or more nonzero elements in the previous bitmap.

19. The apparatus of claim 17, wherein determining whether there is a fault in identifying the nonzero valued activation or the nonzero valued weight comprises:
determining whether the number of one or more nonzero elements in the bitmap is greater than a number of the one or more nonzero valued activations in the activation operand.

20. The apparatus of claim 17, wherein identifying the nonzero valued activation in the compressed activation operand comprises:
after determining that there is a fault in identifying the nonzero valued activation, generating a first bitmap and a second bitmap based on the activation sparsity vector and the weight sparsity vector;
determining a position of the nonzero valued activation in the compressed activation operand based on the bitmap;
determining a first position of the nonzero valued activation in the compressed activation operand based on the first bitmap;
determining a second position of the nonzero valued activation in the compressed activation operand based on the second bitmap; and
identifying the nonzero valued activation in the compressed activation operand based on the position, the first position, and the second position.
